(19) United States
(12) Patent Application Publication
(10) Pub. No.: US 2013/0033235 A1
(43) Pub. Date: Feb. 7, 2013

(54) POWER SUPPLY APPARATUS, CONTROL METHOD, AND RECORDING MEDIUM

(71) Applicant: Yudai Fukaya, Tokyo (JP)

(72) Inventor: Yudai Fukaya, Tokyo (JP)

(73) Assignee: CANON KABUSHIKI KAISHA, Tokyo (JP)

(21) Appl. No.: 13/565,602

(22) Filed: Aug. 2, 2012

(30) Foreign Application Priority Data
Aug. 4, 2011 (JP) 2011-171133

(51) Int. Cl. H02J 7/00; H02J 9/00; H02J 17/00

(52) U.S. Cl. 320/162; 307/104; 307/66

(57) ABSTRACT

A power supply apparatus includes a power supply unit that outputs power wirelessly to an electronic device and a setting unit that sets a first time and a second time. The first time includes a period of time that the power supply unit outputs the first power. The second time includes a period of time that the power supply unit outputs the second power.

### BACKGROUND OF THE INVENTION

1. Field of the Invention

The present invention relates to a power supply apparatus that performs a power supply operation, a method for controlling the power supply apparatus, and a recording medium storing a related program.

2. Description of the Related Art

In a conventional system including a power supply apparatus and an electronic device, the power supply apparatus supplies power wirelessly (without connecting a connector) to the electronic device and the electronic device charges a battery while the power is supplied wirelessly from the power supply apparatus. For example, as discussed in Japanese Patent Application Laid-Open No. 2008-113519, in such a system, it is conventionally known that the power supply apparatus is equipped with a common antenna that is usable for data communication to transmit a command to the electronic device and for power supply to transmit power to the electronic device.

For example, a conventional power supply apparatus transmits a charge instruction command to an electronic device and, if a response is returned from the electronic device, lowers its output resistance to output charging power that enables the electronic device to charge a battery.

However, when the power supply apparatus communicates with the electronic device to transmit a control command, the power supply apparatus sets its output resistance to be a higher value to receive a response from the electronic device. In such a case, the power to be output from the power supply apparatus to the electronic device while the power supply apparatus communicates with the electronic device using the command, becomes smaller than the charging power supplied to the electronic device.

For example, when the electronic device performs a specific operation using the power supplied from the power supply apparatus, if the level of the power supplied from the power supply apparatus to the electronic device changes, the power supply apparatus may not supply the required power to the electronic device. The electronic device cannot perform the specific operation continuously. Therefore, each time when the power supply apparatus performs a process for communicating with the electronic device by using a command, the electronic device cannot perform the specific operation using the power supplied from the power supply apparatus. As a result, the specific operation may be interrupted undesirably. In this case, even when the required power is supplied again from the power supply apparatus, the electronic device is required to restart the interrupted specific operation. The load of the electronic device increases significantly.

### SUMMARY OF THE INVENTION

Therefore, one aspect of the present invention provides a technique enabling a power supply apparatus to communicate with an electronic device without interrupting an operation currently performed by the electronic device.

According to an aspect of the present invention, a power supply apparatus including a power supply unit that supplies power wirelessly to an electronic device, and a setting unit that sets a first time and a second time, wherein the first time includes a period of time that the power supply unit outputs the first power, the first power is used for communicating with the electronic device, the second time includes a period of time that the power supply unit outputs the second power, and the second power is greater than the first power.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a power supply system according to a first exemplary embodiment of the present invention.

FIG. 2 is a flowchart illustrating an example of a setting process that can be performed by the power supply apparatus according to the first exemplary embodiment of the present invention.

FIG. 3 is a flowchart illustrating an example of a power supply control process that can be performed by the power supply apparatus according to the first exemplary embodiment of the present invention.

FIG. 4 is a flowchart illustrating an example of a command reception process that can be performed by an electronic device according to the first exemplary embodiment of the present invention.

FIG. 5 is a flowchart illustrating an example of a first charging process that can be performed by the electronic device according to the first exemplary embodiment of the present invention.

FIG. 6 is a flowchart illustrating an example of a second charging process that can be performed by the electronic device according to the first exemplary embodiment of the present invention.

FIG. 7 is a flowchart illustrating an example of a third charging process that can be performed by the electronic device according to the first exemplary embodiment of the present invention.

### DESCRIPTION OF THE EMBODIMENTS

Various exemplary embodiments, features, and aspects of the invention will be described in detail below with reference to the drawings.

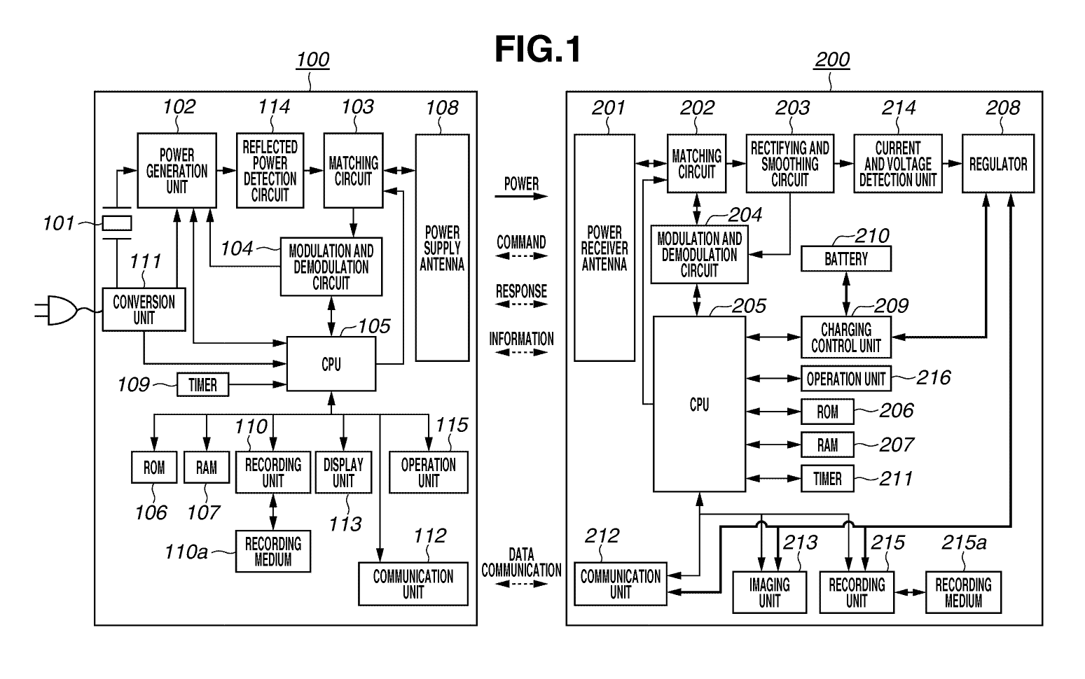

A power supply system according to a first exemplary embodiment according to the present invention is described in detail with reference to attached drawings. The power supply system according to the first exemplary embodiment includes a power supply apparatus 100 and an electronic device 200 illustrated in FIG. 1. In the power supply system according to the first exemplary embodiment, the power supply apparatus 100 can supply power wirelessly to the electronic device 200 via a power supply antenna 108, for example, when the electronic device 200 is placed on the power supply apparatus 100.

Further, in a state where the distance between the power supply apparatus 100 and the electronic device 200 is in a predetermined range, the electronic device 200 including a power receiver antenna 201 can receive power wirelessly from the power supply apparatus 100 via the power receiver antenna 201. Further, the electronic device 200 can charge a battery 210 attached to the electronic device 200 while power is received from the power supply apparatus 100 via the power receiver antenna 201.

Further, in a state where the distance between the power supply apparatus 100 and the electronic device 200 is not in the predetermined range, the electronic device 200 cannot receive power from the power supply apparatus 100 via the power receiver antenna 201.

The above-described predetermined range is a range in which the electronic device 200 can perform communications while power is supplied from the power supply apparatus 100.

In the present exemplary embodiment, the power supply apparatus 100 can supply power wirelessly to a plurality of electronic devices, simultaneously.

The electronic device 200 can be any electronic device that can perform various operations when power is supplied from the battery 210. For example, the electronic device 200 is an imaging apparatus (e.g., a digital still camera, a digital video camera, or the like) or a reproduction apparatus (e.g., a player) that can reproduce audio data and video data. Further, the electronic device 200 can be a mobile apparatus, such as a portable telephone.

Further, the electronic device 200 can be a battery pack that includes the battery 210.

Further, the electronic device 200 is a vehicle or the like that can be driven while power is supplied from the power supply apparatus 100. Further, the electronic device 200 can be a television receiver or a display apparatus that can display video data.

FIG. 1 is a block diagram illustrating the power supply system that includes the power supply apparatus 100 and the electronic device 200. The power supply apparatus 100, as illustrated in FIG. 1, includes an oscillator 101, a power generation unit 102, a matching circuit 103, a modulation and demodulation circuit 104, a central processing unit (CPU) 105, a read only memory (ROM) 106, a random access memory (RAM) 107, the power supply antenna 108, a timer 109, a recording unit 110 and a conversion unit 111. Further, as illustrated in FIG. 1, the power supply apparatus 100 includes a communication unit 112, a display unit 113, a reflected power detection circuit 114, and an operation unit 115.

The oscillator 101 can generate frequency oscillation that can be used to control the power generation unit 102 in such a way as to convert the power supplied from an AC power source (not illustrated) via the conversion unit 111 to the power generation unit 102 into power corresponding to a target value having been set by the CPU 105. For example, the oscillator 101 is a quarts oscillator.

The power generation unit 102 can generate power to be output to an external device via the power supply antenna 108 based on the power supplied from the conversion unit 111 and the oscillation frequency of the oscillator 101. The power generation unit 102 includes an internal field effect transistor (FET), and generates power to be output to an external device by controlling the current flowing between source and drain terminals of the internal FET according to the oscillation frequency of the oscillator 101. The power generated by the power generation unit 102 is supplied to the matching circuit 103 via the reflected power detection circuit 114. Further, the power generated by the power generation unit 102 includes first power and second power.

The first power is electric power to be required when the power supply apparatus 100 transmits an electronic device control command to the electronic device 200. The second power is electric power to be supplied to the electronic device 200 when the power supply apparatus 100 supplies power to the electronic device 200. For example, the first power is equal to or less than 1 W. The second power is within a range of 2 W to 10 W. In the present exemplary embodiment, the second power can be equal to or greater than 10 W. In the present exemplary embodiment, the first power is lower than the second power.

When the power supply apparatus 100 is supplying the first power to the electronic device 200, the power supply apparatus 100 can transmit a command to the electronic device 200 via the power supply antenna 108. However, when the power supply apparatus 100 is supplying the second power to the electronic device 200, the power supply apparatus 100 cannot transmit any command to the electronic device 200 via the power supply antenna 108. Further, the first power is electric power that can be set by the CPU 105 so that the power supply apparatus 100 can transmit a command to any apparatus other than the electronic device 200 via the power supply antenna 108.

The CPU 105 can control the power generation unit 102 in such a way as to switch the power to be supplied to the electronic device 200 to either one of the first power and the second power.

The matching circuit 103 is a resonance circuit that causes the power supply antenna 108 to resonate with a power receiver antenna of a power supply target apparatus of the power supply apparatus 100 at the oscillation frequency of the oscillator 101.

The matching circuit 103 includes circuit elements, such as a variable capacitor, a variable coil, and a resistor. The matching circuit 103 performs impedance matching between the power generation unit 102 and the power supply antenna 108 using the above-described circuit elements.

The CPU 105 can control setting values of a variable capacitor (not illustrated) and a variable coil (not illustrated) to set the oscillation frequency of the oscillator 101 to a resonance frequency f. The resonance frequency f is a frequency at which the power supply apparatus 100 resonates with a power supply target apparatus of the power supply apparatus 100.

The resonance frequency f can be the commercial frequency (i.e., 50/60 Hz) or can be any frequency within a range from 10 kHz to several hundred kHz, or can be a higher frequency of about 10 MHz.

Further, the matching circuit 103 can detect a change in the current flowing through the power supply antenna 108 and a change in the voltage supplied to the power supply antenna 108.

In a state where the oscillation frequency of the oscillator 101 is set to be equal to the resonance frequency f, the power generated by the power generation unit 102 is supplied to the power supply antenna 108 via the matching circuit 103.

The modulation and demodulation circuit 104 can modulate the power generated by the power generation unit 102 according to a predetermined protocol to transmit an electronic device control command to the electronic device 200. The predetermined protocol is, for example, a communication protocol that conforms to ISO/IEC 18092 standards, such as Radio Frequency Identification (RFID). Further, the predetermined protocol can be a communication protocol that conforms to Near Field Communication (NFC) standards. The modulation and demodulation circuit 104 converts the power generated by the power generation unit 102 into a pulse signal, as a command to be used to communicate with the electronic device 200 and transmits the pulse signal to the electronic device 200 via the power supply antenna 108.

The electronic device 200 analyzes the pulse signal transmitted from the power supply apparatus 100 and detects a bit data including “1” information and “0” information. The command includes identification information required to identify an address and a command code indicating an operation to be instructed by the command. The CPU 105 can transmit a command exclusively to the electronic device 200 by controlling the modulation and demodulation circuit 104 in such a way as to change the identification information included in the command.

Further, the CPU 105 can transmit a command to the electronic device 200 and an apparatus other than the electronic device 200 by controlling the modulation and demodulation circuit 104 in such a way as to change the identification information included in the command.

The modulation and demodulation circuit 104 converts the power generated by the power generation unit 102 into a pulse signal based on Amplitude Shift Keying (ASK) modulation (i.e., amplitude variation based modulation). The ASK modulation is employable for an IC card and a card reader that can communicate with the IC card wirelessly.

The modulation and demodulation circuit 104 changes the amplitude of the power generated by the power generation unit 102 by switching an analog multiplier and a load resistor included in the modulation and demodulation circuit 104. Thus, the modulation and demodulation circuit 104 changes the power generated by the power generation unit 102 into a pulse signal. The pulse signal changed by the modulation and demodulation circuit 104 is supplied to the power supply antenna 108 and transmitted, as a command, to the electronic device 200.

Further, the modulation and demodulation circuit 104 includes an encoding circuit that is operable according to a predetermined encoding method.

The modulation and demodulation circuit 104 can cause the encoding circuit to demodulate a response received from the electronic device 200 responding to the command transmitted to the electronic device 200 or information received from the electronic device 200, in response to a change in the current flowing through the power supply antenna 108 that can be detected by the matching circuit 103. Thus, the modulation and demodulation circuit 104 can receive, from the electronic device 200, the response replying to the command transmitted to the electronic device 200 according to a load modulation method or the information received from the electronic device 200.

The modulation and demodulation circuit 104 transmits a command to the electronic device 200 according to an instruction from the CPU 105. Further, if a response or information is received from the electronic device 200, the modulation and demodulation circuit 104 demodulates the received response or information and supplies the demodulated response or information to the CPU 105.

In a state where the AC power source (not illustrated) is connected to the power supply apparatus 100, the CPU 105 can control the power supply apparatus 100 while power is supplied from the AC power source (not illustrated) via the conversion unit 111. Further, the CPU 105 can control the power supply apparatus 100 by executing a computer program stored in the ROM 106. The CPU 105 can control the power to be supplied to the electronic device 200 by controlling the power generation unit 102. Further, the CPU 105 can transmit a command to the electronic device 200 by controlling the modulation and demodulation circuit 104.

The ROM 106 stores computer programs required to control the power supply apparatus 100 and information or parameters relating to the power supply apparatus 100. Further, the ROM 106 can store video data to be displayed on the display unit 113.

The RAM 107 is a rewritable memory, which can temporarily store the computer programs required to control the power supply apparatus 100, the information or parameters relating to the power supply apparatus 100, and information received from the electronic device 200 via the modulation and demodulation circuit 104. In the present exemplary embodiment, the RAM 107 stores a value indicating a power receiving efficiency of the electronic device 200. The value indicating the power receiving efficiency of the electronic device 200 is a value indicating the power that the electronic device 200 can receive from the power supply apparatus 100 relative to the power that the power supply apparatus 100 has supplied to the electronic device 200.

In the present exemplary embodiment, the value indicating the power receiving efficiency of the electronic device 200 is a percentage indicating a value obtainable by dividing the power that the electronic device 200 can receive from the power supply apparatus 100 by the power that the power supply apparatus 100 has supplied to the electronic device 200. Alternatively, the value indicating the power receiving efficiency of the electronic device 200 can be calculated by the CPU 105. Further, when the electronic device 200 can calculate a value indicating the power receiving efficiency of the electronic device 200, the power supply apparatus 100 can acquire the calculated value from the electronic device 200.

The power supply antenna 108 is an antenna that can output the power generated by the power generation unit 102 to an external device. The power supply apparatus 100 supplies power to the electronic device 200 via the power supply antenna 108 and transmits a command to the electronic device 200 via the power supply antenna 108. Further, the power supply apparatus 100 receives a command from the electronic device 200 via the power supply antenna 108, a response replying to a command transmitted to the electronic device 200, and information transmitted from the electronic device 200.

The timer 109 measures the momentary time and can obtain time information relating to operations or processes performed by the power supply apparatus 100. Further, a threshold value applicable to the time measured by the timer 109 is stored beforehand in the ROM 106.

The recording unit 110 records video data and audio data, if these data are received by the communication unit 112, on a recording medium 110a. Further, the recording unit 110 can read the recorded data (i.e., video data and audio data) from the recording medium 110a and can supply readout data to the RAM 107, the communication unit 112, and the display unit 113. For example, the recording medium 110a is a hard disk or a memory card, and can be a built-in medium provided in the power supply apparatus 100 or an external recording medium that is attachable to or detachable from the power supply apparatus 100.

In a state where the AC power source (not illustrated) is connected to the power supply apparatus 100, the conversion unit 111 can convert alternating-current power supplied from the AC power source (not illustrated) into direct-current power and can supply the converted direct-current power to the power supply apparatus 100.

The communication unit 112 can transmit video data and audio data, if these data are supplied from any one of the RAM 107 and recording medium 110a, to the electronic device 200. Further, the communication unit 112 can receive video data and audio data transmitted from the electronic device 200 to the power supply apparatus 100.

The communication unit 112 can perform wireless communications in conformity to 802.11a,b,g,n standards regulated according to the wireless LAN standards. Further, the communication unit 112 can perform transmission or reception of video data and audio data by modulating the data into a signal conforming to the wireless LAN standards.

The communication unit 112 can receive video data and audio data from the electronic device 200 or can transmit video data and audio data to the electronic device 200 in a state where the modulation and demodulation circuit 104 is transmitting a command to the electronic device 200 via the power supply antenna 108. Further, the communication unit 112 can receive video data and audio data from the electronic device 200 or can transmit video data and audio data to the electronic device 200 in a state where the modulation and demodulation circuit 104 is receiving a response or information transmitted from the electronic device 200 via the power supply antenna 108.

Further, the communication unit 112 can transmit an electronic device control signal or data from the power supply apparatus 100 to the electronic device 200. Further, the communication unit 112 can receive a signal or data transmitted from the electronic device 200 to the power supply apparatus 100.

The display unit 113 can display any one of video data read from recording medium 110a via the recording unit 110, video data supplied from the RAM 107, video data supplied from the ROM 106, and video data supplied from the communication unit 112.

The reflected power detection circuit 114 can detect information indicating an amplitude voltage V1 of a traveling wave of the power having been output via the power supply antenna 108 to an external device and information indicating an amplitude voltage V2 of a reflected wave of the power having been output via the power supply antenna 108 to an external device. The information detected by the reflected power detection circuit 114 (i.e., the information indicating the amplitude voltage V1 and the information indicating the amplitude voltage V2) is supplied to the CPU 105. The CPU 105 stores the information supplied from the reflected power detection circuit 114 (i.e., the information indicating the amplitude voltage V1 and the information indicating the amplitude voltage V2) in the RAM 107.

The CPU 105 calculates a voltage standing wave ratio (VSWR) based on the amplitude voltage V1 of the traveling wave and the amplitude voltage V2 of the reflected wave.

The following formula (1) represents a voltage reflection coefficient ρ.

$$ρ = \frac{V 2}{V 1} \qquad ( 1 )$$

The following formula (2) represents the voltage standing wave ratio (VSWR).

$$VSWR = \frac{1 + ρ}{1 - ρ} \qquad ( 2 )$$

In the following description, the voltage standing wave ratio is simply referred to as “VSWR.”

The VSWR is a value indicating a relationship between the traveling wave of the power output via the power supply antenna 108 and the reflected wave of the power output via the power supply antenna 108. When the VSWR value is adjacent to 1, the reflected power is small and the loss of the power supplied from the power supply apparatus 100 to an external electronic device is small, and the efficiency is high.

The CPU 105 determines whether the electronic device 200 is present in the vicinity of the power supply apparatus 100 with reference to the calculated VSWR value.

The operation unit 115 provides a user interface that enables users to operate the power supply apparatus 100. The operation unit 115 includes a power button for the power supply apparatus 100 and a mode switch button for the power supply apparatus 100. Each button can be constituted by a switch, a touch panel, or the like. The CPU 105 controls the power supply apparatus 100 according to a user instruction that can be input via the operation unit 115.

Further, the power supply apparatus 100 can include a speaker unit (not illustrated). The speaker unit (not illustrated) can output any one of audio data read from the recording medium 110a via the recording unit 110, audio data supplied from the ROM 106, audio data supplied from the RAM 107, and audio data supplied from the communication unit 112.

Next, an example configuration of the electronic device 200 is described below with reference to FIG. 1.

In the following description, a digital still camera is an example of the electronic device 200.

The electronic device 200 includes the power receiver antenna 201, a matching circuit 202, a rectifying and smoothing circuit 203, a modulation and demodulation circuit 204, a CPU 205, a ROM 206, a RAM 207, a regulator 208, a charging control unit 209, the battery 210, and a timer 211. Further, the electronic device 200 includes a communication unit 212, an imaging unit 213, a current and voltage detection unit 214, a recording unit 215, and an operation unit 216.

The power receiver antenna 201 is an antenna that can receive power supplied from the power supply apparatus 100. The electronic device 200 can receive power and can receive a command from the power supply apparatus 100 via the power receiver antenna 201. Further, the electronic device 200 can receive a command from the power supply apparatus 100 via the power receiver antenna 201 and can transmit a response replying to the command received from the power supply apparatus 100 to the power supply apparatus 100.

The matching circuit 202 is a resonance circuit that can perform impedance matching in such a way as to cause the power receiver antenna 201 to resonate at a frequency similar to the resonance frequency f of the power supply apparatus 100. Similar to the matching circuit 103, the matching circuit 202 includes a capacitor, a coil, a variable capacitor, a variable coil, and a resistor. The matching circuit 202 controls a capacitance value of the variable capacitor, an inductance value of the variable coil, and an impedance value of the variable resistor in such a way as to cause the power receiver antenna 201 to resonate at the frequency similar to the resonance frequency f of the power supply apparatus 100. Further, the matching circuit 202 can supply the power received via the power receiver antenna 201 to the rectifying and smoothing circuit 203.

The rectifying and smoothing circuit 203 can generate direct-current power, while extracting a command and noise components from the power received via the power receiver antenna 201. Further, the rectifying and smoothing circuit 203 can supply the generated direct-current power to the regulator 208 via the current and voltage detection unit 214. The rectifying and smoothing circuit 203 supplies a command, if it is extracted from the power received via the power receiver antenna 201, to the modulation and demodulation circuit 204.

In the present exemplary embodiment, the rectifying and smoothing circuit 203 includes rectifying diodes to generate direct-current power through full-wave rectification or half-wave rectification. The direct-current power generated by the rectifying and smoothing circuit 203 can be supplied to the regulator 208.

The modulation and demodulation circuit 204 analyzes the command supplied from the rectifying and smoothing circuit 203 according to communication protocols determined beforehand in relation to the power supply apparatus 100, and supplies a command analysis result to the CPU 205.

In a state where power is supplied from the power supply apparatus 100 to the electronic device 200, the CPU 205 controls the modulation and demodulation circuit 204 to change a load included in the modulation and demodulation circuit 204 to transmit a response replying to a command to the power supply apparatus 100. When the load included in the modulation and demodulation circuit 204 changes, the current flowing through the power supply antenna 108 changes correspondingly. Thus, the power supply apparatus 100 can receive the response replying to the command transmitted from the electronic device 200 by detecting a change in the current flowing through the power supply antenna 108.

The CPU 205 identifies the command received via the modulation and demodulation circuit 204 with reference to the analysis result supplied from the modulation and demodulation circuit 204 and controls the electronic device 200 to perform a process or an operation designated by a command code that corresponds to the received command.

Further, the CPU 205 controls the electronic device 200 by executing a computer program stored in the ROM 206.

The ROM 206 stores the computer program required to control the electronic device 200. Further, the ROM 206 stores identification information of the electronic device 200, device information of the electronic device 200, and display data. The identification information of the electronic device 200 is information indicating ID of the electronic device 200. The device information of the electronic device 200 is information indicating the type (device type) of the electronic device 200, manufacturer name of the electronic device 200, apparatus name of the electronic device 200, manufacturing year/month/day of the electronic device 200, and power receiving information of the electronic device 200.

The power receiving information of the electronic device 200 includes information indicating the maximum power that can be received by the electronic device 200 and information indicating the minimum power that can be received by the electronic device 200.

The RAM 207 is a rewritable memory that can temporarily stores the computer program required to control the electronic device 200 and information received from the power supply apparatus 100. Further, the RAM 207 can store operation information of the electronic device 200 that indicates the operational state of the electronic device 200.

The operation information of the electronic device 200 includes information indicating the operation mode of the electronic device 200 and information indicating the power required when the electronic device 200 performs the operation.

For example, in a case where the electronic device 200 communicates with the power supply apparatus 100 via the communication unit 212, the operation information of the electronic device 200 includes information indicating that the operation mode of the electronic device 200 is a communication mode and information indicating the power required when the electronic device 200 operates the communication unit 212.

Further, for example, in a case where the electronic device 200 performs a shooting operation, the operation information of the electronic device 200 includes information indicating that the operation mode of the electronic device 200 is a shooting mode and information indicating the power required when the electronic device 200 operates the imaging unit 213, the recording unit 215, and a recording medium 215a. Further, for example, in a case where the electronic device 200 performs a charging operation, the operation information of the electronic device 200 includes information indicating that the operation mode of the electronic device 200 is a charging mode and information indicating the power required when the electronic device 200 charges the battery 210.

Further, in a case where the electronic device 200 communicates with the power supply apparatus 100 via the communication unit 212 while charging the electronic device 200, the operation information of the electronic device 200 includes information indicating that the operation mode of the electronic device 200 is a charging/communication mode. In this case, the operation information of the electronic device 200 includes information indicating the power required when the electronic device 200 charges the battery 210 and information indicating the power required when the electronic device 200 operates the communication unit 212. In the present exemplary embodiment, the power required when the electronic device 200 performs the operation is hereinafter referred to as “operation power W.”

The regulator 208 controls one of the direct-current power supplied from the rectifying and smoothing circuit 203 or the power supplied from the battery 210 to have a voltage value equivalent to a voltage value set by the CPU 205. For example, the regulator 208 is a switching regulator or can be a linear regulator.

According to an instruction from the CPU 205, the regulator 208 determines whether to supply the power received from the battery 210 to the electronic device 200 or supply the power received from the power supply apparatus 100 via the rectifying and smoothing circuit 203 to the electronic device 200.

In a state where any one of the battery 210 and the power supply apparatus 100 is supplying direct-current power, the regulator 208 performs a control to deliver the supplied power to the CPU 205, the ROM 206, the RAM 207, and the timer 211. Further, in the state where any one of the battery 210 and the power supply apparatus 100 is supplying power, the regulator 208 performs a control to deliver the supplied power to the modulation and demodulation circuit 204, the matching circuit 202, the rectifying and smoothing circuit 203, and the current and voltage detection unit 214.

In a state where power is supplied from the regulator 208, the charging control unit 209 charges the battery 210. In this case, the charging of the charging control unit 209 is performed according to a constant-voltage and constant-current method. Further, the charging control unit 209 periodically detects information relating to the charging of the battery 210 and supplies the detected information to the CPU 205. In the present exemplary embodiment, the information relating to the charging of the battery 210 is hereinafter referred to as “charging information.” The CPU 205 stores the charging information in the RAM 207.

The charging information includes remaining capacity information indicating the remaining capacity of the battery 210. The charging information may include information indicating whether the battery 210 is in a fully charged state in addition to the remaining capacity information, and may include information indicating the time elapsed since the charging control unit 209 started charging the battery 210. Further, charging information can include information indicating that the charging control unit 209 is charging the battery 210 according to a constant-voltage control and information indicating that the charging control unit 209 is charging the battery 210 according to a constant-current control.

Further, when the charging control unit 209 charges the battery 210, the charging control unit 209 detects the current flowing through the battery 210 and the voltage supplied to the battery 210. The charging control unit 209 supplies the detected current and voltage values to the CPU 205. The CPU 205 stores the information indicating the current flowing through the battery 210 and the information indicating the voltage supplied to the battery 210, which are supplied from the charging control unit 209, in the RAM 207.

The battery 210 is attachable to and detachable from the electronic device 200. Further, the battery 210 is a chargeable secondary battery, such as a lithium-ion battery.

The timer 211 measures the momentary time and can obtain time information relating to operations and processes performed by the electronic device 200. Further, a threshold value applicable to the time measured by the timer 211 is stored beforehand in the ROM 206.

The communication unit 212 can transmit video data and audio data stored in the ROM 206 or recorded on the recording medium 215a to the power supply apparatus 100 and can receive video data and audio data from the power supply apparatus 100.

The communication unit 212 performs transmission and reception of video data and audio data according to communication protocols that are commonly applied to the communication unit 112. Further, for example, the communication unit 212 can transmit and receive video data and audio data according to 802.11a,b,g,n standards regulated for the wireless LAN.

The imaging unit 213 includes an image sensor that can generate video data based on an optical image of an object to be captured, an image process circuit that can perform image processing on the video data generated by the image sensor, and a compression/decompression circuit that can compress video data and can decompress compressed video data. The imaging unit 213 performs an imaging operation to capture an image of an object, and supplies video data of still images and moving images obtained by the imaging operation to the recording unit 215. The recording unit 215 records the video data supplied from the imaging unit 213 on the recording medium 215a. The imaging unit 213 can further include any configuration required to perform the imaging operation.

The current and voltage detection unit 214 can detect current information indicating a current value of the power supplied from the rectifying and smoothing circuit 203 and voltage information indicating a voltage value of the power supplied from the rectifying and smoothing circuit 203.

The current information and the voltage information detected by the current and voltage detection unit 214 can be supplied to the CPU 205.

The CPU 205 stores, in the RAM 207, the current information and the voltage information supplied from the current and voltage detection unit 214. Further, the CPU 205 can calculate power transmitted from the power supply apparatus 100 to the electronic device 200 with reference to the current information and the voltage information supplied from the current and voltage detection unit 214.

The recording unit 215 records video data and audio data supplied from any one of the communication unit 212 and the imaging unit 213 on the recording medium 215a. Further, the recording unit 215 can read video data and audio data from the recording medium 215a and can supply the readout data to the RAM 207 and the communication unit 212. For example, the recording medium 215a is a hard disk or a memory card, and can be a built-in medium provided in the electronic device 200, or can be an external recording medium that is attachable to or detachable from the electronic device 200.

The operation unit 216 provides a user interface that enables users to operate the electronic device 200. The operation unit 216 includes a power button that is usable to activate the electronic device 200 and a mode switch button that is usable to switch the operation mode of the electronic device 200. Each button can be constituted by a switch or a touch panel. The CPU 205 controls the electronic device 200 according to a user instruction input via the operation unit 216. For example, the operation unit 216 can be configured to control the electronic device 200 according to a remote-control signal received from a remote controller (not illustrated).

In the present exemplary embodiment, each of the power supply antenna 108 and the power receiver antenna 201 can be a helical antenna, a loop antenna, or a planar antenna (e.g., a meander line antenna).

The operation mode of the electronic device 200 includes a first charging mode and a second charging mode in addition to the shooting mode, the reproduction mode, and the communication mode.

When the operation mode of the electronic device 200 is the shooting mode, the electronic device 200 performs a shooting operation. In a state where the distance between the power supply apparatus 100 and the electronic device 200 is within the predetermined range, if the operation mode of the electronic device 200 is the shooting mode, the power received from the power supply apparatus 100 can be supplied to the imaging unit 213, the recording unit 215, and the recording medium 215a.

In the state where the distance between the power supply apparatus 100 and the electronic device 200 is within the predetermined range, if the operation mode of the electronic device 200 is the shooting mode, the electronic device 200 prevents the power received from the power supply apparatus 100 from being supplied to the communication unit 212.

When the operation mode of the electronic device 200 is the reproduction mode, the electronic device 200 reproduces the data recorded on the recording medium 215a. In the state where the distance between the power supply apparatus 100 and the electronic device 200 is within the predetermined range, if the operation mode of the electronic device 200 is the reproduction mode, the power received from the power supply apparatus 100 can be supplied to the recording unit 215 and the recording medium 215a. In the state where the distance between the power supply apparatus 100 and the electronic device 200 is within the predetermined range, if the operation mode of the electronic device 200 is the reproduction mode, the electronic device 200 prevents the power received from the power supply apparatus 100 from being supplied to the communication unit 212 and the imaging unit 213.

When the operation mode of the electronic device 200 is the communication mode, the electronic device 200 communicates with an external apparatus via the communication unit 212. In the state where the distance between the power supply apparatus 100 and the electronic device 200 is within the predetermined range, if the operation mode of the electronic device 200 is the communication mode, the power received from the power supply apparatus 100 can be supplied to the communication unit 212, the recording unit 215, and the recording medium 215a. In the state where the distance between the power supply apparatus 100 and the electronic device 200 is within the predetermined range, if the operation mode of the electronic device 200 is the communication mode, the electronic device 200 prevents the power received from the power supply apparatus 100 from being supplied to the imaging unit 213.

When the operation mode of the electronic device 200 is the first charging mode, the electronic device 200 charges the battery 210. In the state where the distance between the power supply apparatus 100 and the electronic device 200 is within the predetermined range, if the operation mode of the electronic device 200 is the first charging mode, the power received from the power supply apparatus 100 can be supplied to the charging control unit 209 and the battery 210. In the state where the distance between the power supply apparatus 100 and the electronic device 200 is within the predetermined range, if the operation mode of the electronic device 200 is the first charging mode, the electronic device 200 prevents the power from being supplied from the power supply apparatus 100 to the communication unit 212, the imaging unit 213, the recording unit 215, and the recording medium 215a.

When the operation mode of the electronic device 200 is the second charging mode, the electronic device 200 performs at least one of an imaging operation, a reproducing operation, and a communicating operation while charging the battery 210. In the state where the distance between the power supply apparatus 100 and the electronic device 200 is within the predetermined range, if the operation mode of the electronic device 200 is the second charging mode, the power received from the power supply apparatus 100 can be supplied to the electronic device 200 according to an operation instruction input via the operation unit 216.

In the state where the distance between the power supply apparatus 100 and the electronic device 200 is within the predetermined range, if the operation mode of the electronic device 200 is the second charging mode, and if a shooting instruction is input via the operation unit 216, the power received from the power supply apparatus 100 can be supplied to the charging control unit 209 and the battery 210. In this case, the power received from the power supply apparatus 100 can be also supplied to the imaging unit 213, the recording unit 215, and the recording medium 215a.

Further, in the state where the distance between the power supply apparatus 100 and the electronic device 200 is within the predetermined range, if the operation mode of the electronic device 200 is the second charging mode, and if a reproduction instruction is input via the operation unit 216, the power received from the power supply apparatus 100 can be supplied to the charging control unit 209 and the battery 210. In this case, the power received from the power supply apparatus 100 can be also supplied to the recording unit 215 and the recording medium 215a.

Further, in the state where the distance between the power supply apparatus 100 and the electronic device 200 is within the predetermined range, if the operation mode of the electronic device 200 is the second charging mode, and if a communication instruction is input to the communication unit 212 via the operation unit 216, the power received from the power supply apparatus 100 can be supplied to the battery 210. In this case, the power received from the power supply apparatus 100 can be also supplied to the charging control unit 209, the communication unit 212, the recording unit 215, and the recording medium 215a.

When the operation mode of the electronic device 200 is the second charging mode, the electronic device 200 prevents the power received from the power supply apparatus 100 from being supplied to a part of the electronic device 200 that is not required to operate.

When the operation mode of the electronic device 200 is the first charging mode, if an instruction requesting at least one of an imaging operation, a reproducing operation, and a communicating operation is input to the electronic device 200 via the operation unit 216, the operation mode of the electronic device 200 is changed to the second charging mode. Further, when the operation mode of the electronic device 200 is the second charging mode, if the operation corresponding to an operation instruction input via the operation unit 216 is completed, the operation mode of the electronic device 200 is changed to the first charging mode.

If an instruction requesting at least one of the imaging operation, the reproducing operation, and the communicating operation is input to the electronic device 200 via the operation unit 216, the electronic device 200 performs a process according to the operation instruction. However, the instruction requesting at least one of the imaging operation, the reproducing operation, and the communicating operation can be an instruction transmitted from the power supply apparatus 100 to the electronic device 200. Further, the instruction requesting at least one of the imaging operation, the reproducing operation, and the communicating operation can be an electronic device remote-controlling operation instruction transmitted from a remote controller to the electronic device 200.

Further, the operation instruction can be any instruction other than the imaging operation, the reproducing operation, and the communicating operation. For example, in a case where the electronic device 200 is a portable phone, the operation instruction can be an instruction to perform a telephone call with the portable phone or can be an instruction to transmit a mail from the portable phone to an external apparatus.

In any operation mode of the electronic device 200, the power received from the power supply apparatus 100 can be supplied to the regulator 208, the CPU 205, the ROM 206, the RAM 207, and the timer 211. Further, in this case, the power received from the power supply apparatus 100 can be also supplied to the modulation and demodulation circuit 204, the matching circuit 202, the rectifying and smoothing circuit 203, the operation unit 216, and the current and voltage detection unit 214.

Further, in the first exemplary embodiment, the process to be performed by the power supply apparatus 100 can be applied to a system in which the power supply apparatus 100 supplies electric power wirelessly to the electronic device 200 through electromagnetic coupling. Similarly, in the first exemplary embodiment, the process to be performed by the electronic device 200 can be applied to the system in which the power supply apparatus 100 supplies electric power wirelessly to the electronic device 200 through electromagnetic coupling.

Further, the present invention can be applied to a system in which an electrode serving as the power supply antenna 108 is provided on the power supply apparatus 100 while an electrode serving as the power receiver antenna 201 is provided on the electronic device 200, and the power supply apparatus 100 supplies electric power to the electronic device 200 through field coupling.

Further, the process to be performed by the power supply apparatus 100 and the process to be performed by the electronic device 200 can be applied to a system in which the power supply apparatus 100 supplies electric power wirelessly to the electronic device 200 through electromagnetic induction.

Further, in the first exemplary embodiment, the power supply apparatus 100 is configured to transmit electric power wirelessly to the electronic device 200 and the electronic device 200 is configured to receive electric power wirelessly from the power supply apparatus 100. However, the technical terminology “wireless” can be replaced by “contactless” or “pointless.”

(Setting Process)

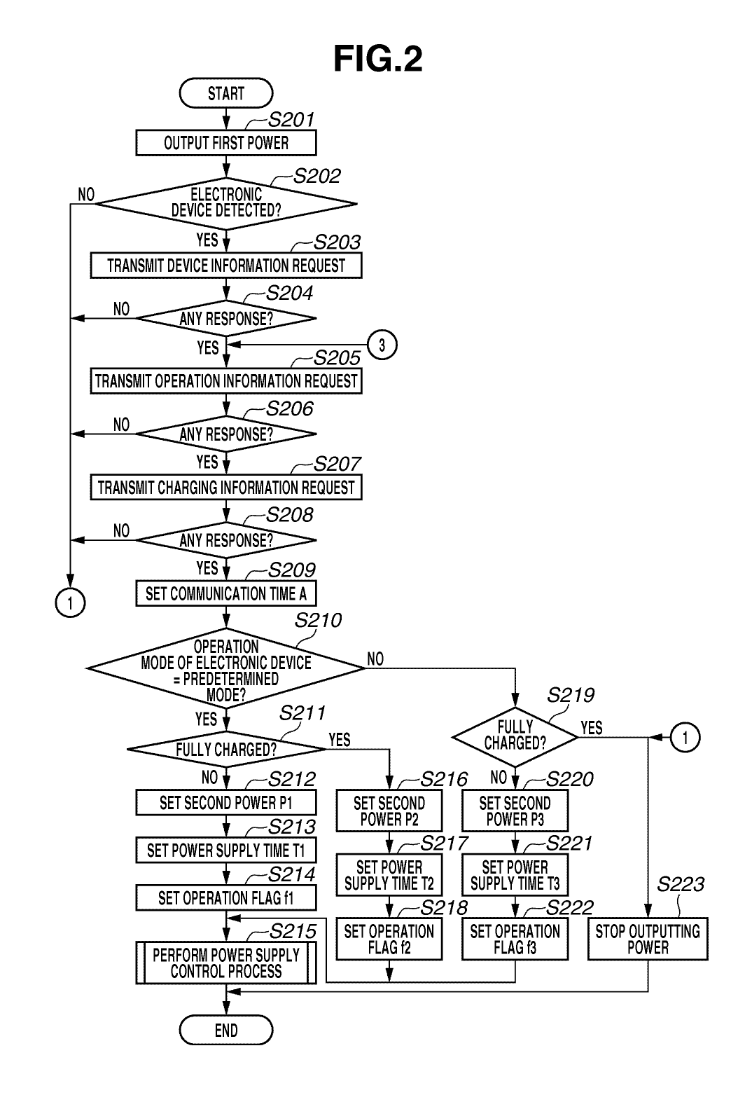

An example setting process that can be performed by the power supply apparatus 100 is described below with reference to a flowchart illustrated in FIG. 2. The setting process illustrated in FIG. 2 can be performed by the power supply apparatus 100 when the power source of the power supply apparatus 100 is ON and when the power supply apparatus 100 can supply electric power. In the present exemplary embodiment, the CPU 105 controls the setting process illustrated in FIG. 2 by executing a computer program stored in the ROM 106.

In step S201, the CPU 105 controls the oscillator 101, the power generation unit 102, and the matching circuit 103 in such a way as to output the first power to determine whether the distance between the power supply apparatus 100 and the electronic device 200 is within the predetermined range. In this case, the process of the present flowchart proceeds from step S201 to step S202. When the first power is output to the electronic device 200, the CPU 105 can transmit information indicating the first power value to the electronic device 200 via the power supply antenna 108.

In step S202, the CPU 105 determines whether the distance between the power supply apparatus 100 and the electronic device 200 is within the predetermined range. For example, the CPU 105 calculates a change in the VSWR value based on the VSWR that can be detected by the reflected power detection circuit 114 and the CPU 105. Further, the CPU 105 determines whether the distance between the power supply apparatus 100 and the electronic device 200 is within the predetermined range based on the calculated change in the VSWR.

If the CPU 105 determines that the distance between the power supply apparatus 100 and the electronic device 200 is within the predetermined range (Yes in step S202), the process of flowchart proceeds from step S202 to step S203. If the CPU 105 determines that the distance between the power supply apparatus 100 and the electronic device 200 is not within the predetermined range (No in step S202), the process of flowchart proceeds from step S202 to step S223.

In step S203, the CPU 105 controls the modulation and demodulation circuit 104 in such a way as to transmit a first command requesting device information of the electronic device 200 to the electronic device 200. In this case, the process of flowchart proceeds from step S203 to step S204.

In step S204, the CPU 105 determines whether the modulation and demodulation circuit 104 has received the device information of the electronic device 200, as a response replying to the first command transmitted to the electronic device 200 in step S203. If the CPU 105 determines that the modulation and demodulation circuit 104 has received the device information of the electronic device 200 (Yes in step S204), the CPU 105 acquires device information of the electronic device 200 from the modulation and demodulation circuit 104 and stores the acquired device information of the electronic device 200 in the RAM 107. In this case (Yes in step S204), the process of flowchart proceeds from step S204 to step S205.

If the CPU 105 determines that the modulation and demodulation circuit 104 has not yet received the device information of the electronic device 200 (No in step S204), the process of flowchart proceeds from step S204 to step S223.

In step S205, the CPU 105 controls the modulation and demodulation circuit 104 in such a way as to transmit a second command requesting operation information of the electronic device 200 to the electronic device 200. In this case, the process of flowchart proceeds from step S205 to step S206.

In step S206, the CPU 105 determines whether the modulation and demodulation circuit 104 has received the operation information of the electronic device 200 as a response replying to the second command transmitted to the electronic device 200 in step S205. If the CPU 105 determines that the modulation and demodulation circuit 104 has received the operation information of the electronic device 200 (Yes in step S206), the CPU 105 acquires the operation information of the electronic device 200 from the modulation and demodulation circuit 104 and stores the acquired operation information of the electronic device 200 in the RAM 107.

In this case (Yes in step S206), the process of flowchart proceeds from step S206 to step S207. If the CPU 105 determines that the modulation and demodulation circuit 104 has not received the operation information of the electronic device 200 (No in step S206), the process of flowchart proceeds from step S206 to step S223.

In step S207, the CPU 105 controls the modulation and demodulation circuit 104 in such a way as to transmit a third command requesting charging information of the electronic device 200 to the electronic device 200. In this case, the process of flowchart proceeds from step S207 to step S208.

In step S208, the CPU 105 determines whether the modulation and demodulation circuit 104 has received the charging information from the electronic device 200 as a response replying to the third command transmitted to the electronic device 200 in step S207. If the CPU 105 determines that the modulation and demodulation circuit 104 has received the charging information from the electronic device 200 (Yes in step S208), the CPU 105 stores the charging information of the electronic device 200 in the RAM 107.

In this case (Yes in step S208), the process of flowchart proceeds from step S208 to step S209. If the CPU 105 determines that the modulation and demodulation circuit 104 has not received the charging information from the electronic device 200 (No in step S208), the process of flowchart proceeds from step S208 to step S223.

In step S209, the CPU 105 sets communication time A with reference to the device information of the electronic device 200 acquired from the electronic device 200. In the present exemplary embodiment, the communication time A indicates a period of time during which the power supply apparatus 100 outputs the first power to the electronic device 200 in a power supply control process described below.

Before the elapsed time reaches the communication time A after the power supply apparatus 100 outputs the first power, the power supply apparatus 100 can communicate with the electronic device 200 using the a command. Before the elapsed time reaches the communication time A after the power supply apparatus 100 outputs the first power, the power supply apparatus 100 can transmit a command to the electronic device 200 to acquire information indicating the operational state of the electronic device 200 or control the electronic device 200.

The information acquired from the electronic device 200 from the power supply apparatus 100 using a command is dependent on the type of the electronic device 200. Therefore, the CPU 105 sets the communication time A according to the device information of the electronic device 200. For example, when the device information of the electronic device 200 includes information indicating that the electronic device 200 is an apparatus that charges the battery 210, the power supply apparatus 100 acquires the charging information of the battery 210 as information indicating the operational state of the electronic device 200.

In the present exemplary embodiment, regardless of the type of the electronic device 200, the power supply apparatus 100 acquires the operation information of the electronic device 200 as the information indicating the operational state of the electronic device 200. If the power supply apparatus 100 is required to acquire a larger amount of information from the electronic device 200, the CPU 205 sets a longer communication time A.

In the first exemplary embodiment, before the elapsed time reaches the communication time A after the power supply apparatus 100 outputs the first power, the power supply apparatus 100 acquires the operation information of the electronic device 200 and the charging information of the electronic device 200. Therefore, in step S209, the CPU 105 sets the communication time A to be sufficient for the power supply apparatus 100 to acquire the operation information of the electronic device 200 and the charging information of the electronic device 200 from the electronic device 200. The communication time A set by the CPU 105 is stored in the RAM 107. When the CPU 105 has completed the setting of the communication time A, the process of flowchart proceeds from step S209 to step S210.

In step S210, the CPU 105 determines whether the operation mode of the electronic device 200 is a predetermined mode with reference to the operation information of the electronic device 200 acquired from the electronic device 200. The CPU 105 detects the operation mode of the electronic device 200 with reference to the operation information of the electronic device 200 and determines whether the operation mode of the electronic device 200 is the predetermined mode. In the present exemplary embodiment, the predetermined mode is at least one of the second charging mode, the shooting mode, the reproduction mode, and the communication mode.

If the CPU 105 determines that the operation mode of the electronic device 200 is the predetermined mode (Yes in step S210), the process of flowchart proceeds from step S210 to step S211. If the CPU 105 determines that the operation mode of the electronic device 200 is not the predetermined mode (No in step S210), the process of flowchart proceeds from step S210 to step S219.

In step S211, the CPU 105 determines whether the battery 210 is in a fully charged state with reference to the charging information of the electronic device 200 acquired from the electronic device 200. If the CPU 105 determines that the battery 210 is in the fully charged state (Yes in step S211), the process of flowchart proceeds from step S211 to step S216. If the CPU 105 determines that the battery 210 is not in the fully charged state (No in step S211), the processing of flowchart proceeds from step S211 to step S212.

In step S212, the CPU 105 sets a second power P1 with reference to the charging information of the electronic device 200 and the operation information of the electronic device 200, which can be acquired from the electronic device 200. In the present exemplary embodiment, the second power P1 is a value indicating the second power that can be output from the power supply apparatus 100 to the electronic device 200 in the power supply control process described below.

The CPU 105 stores the setting value of the second power P1 in the RAM 107. The CPU 105 sets the second power P1 to be equal to or greater than a power value required for the electronic device 200. In this case, the process of flowchart proceeds from step S212 to step S213.

In step S213, the CPU 105 sets a power supply time T1. In the present exemplary embodiment, the power supply time T1 indicates a period of time during which the power supply apparatus 100 outputs the second power P1 to the electronic device 200 in the power supply control process. If the time elapsed since the start timing of the second power P1 output by the power supply apparatus 100 is shorter than the power supply time T1, the power supply apparatus 100 can output the second power P1 to the electronic device 200. If the time elapsed since the start timing of the second power P1 output by the power supply apparatus 100 is shorter than the power supply time T1, the power supply apparatus 100 cannot transmit any command to the electronic device 200.

To enable the power supply apparatus 100 to communicates with the electronic device 200 by using command, the CPU 105 sets the power supply time T1 according to the following formula (3).

$$T 1 [ s ] \geq W [ W ] \times \frac{A [ s ]}{( P 1 [ W ] \times \frac{E [ \% ]}{100} - W [ W ]} \qquad ( 3 )$$

The operation power W in the formula (3) is a value indicating the operation power of the electronic device 200, which is included in the operation information of the electronic device 200 acquired from the electronic device 200. The communication time A in the formula (3) is the value set by the CPU 105 in step S209. The second power P1 in the formula (3) is the value set by the CPU 105 in step S212. The efficiency E in the formula (3) is a value indicating the power receiving efficiency of the electronic device 200 stored in the RAM 107.

For example, in a case where the second power P1 is 8 [W], the efficiency E is 50 [%], the communication time A is 0.2 [S], and the operation power W is 3.5 [W], the CPU 105 sets the power supply time T1 to be equal to or greater than 1.4 [S].

If the setting of the power supply time T1 according to the formula (3) has been completed, the CPU 105 stores the setting value of the power supply time T1 in the RAM 207. In this case, the process of flowchart proceeds from step S213 to step S214.

In step S214, the CPU 105 stores a flag f1 in the RAM 107. The flag f1 is information indicating that the operation mode of the electronic device 200 is the predetermined mode and the battery 210 is not in a fully charged state. When the CPU 105 detects the flag f1, the CPU 105 can determine that the electronic device 200 is performing an operation other than the charging while performing the charging. In this case, the process of flowchart proceeds from step S214 to step S215.

In step S215, the CPU 105 performs the power supply control process as described in detail below. If the power supply control process has been completed, the CPU 105 terminates the process of the flowchart illustrated in FIG. 2.

In step S216, the CPU 105 sets a second power P2 with reference to the operation information of the electronic device 200 acquired from the electronic device 200. In the present exemplary embodiment, the second power P2 is a value indicating the second power that can be output from the power supply apparatus 100 to the electronic device 200 in the power supply control process described below. The CPU 105 stores the setting value of the second power P2 in the RAM 107. The CPU 105 sets the second power P2 to be equal to or greater than the power value required for the electronic device 200. In this case, the process of flowchart proceeds from step S216 to step S217.

In step S217, the CPU 105 sets a power supply time T2. In the present exemplary embodiment, the power supply time T2 indicates a period of time during which the power supply apparatus 100 outputs the second power P2 to the electronic device 200 in the power supply control process. If the time elapsed since the start timing of the second power P2 output by the power supply apparatus 100 is shorter than the power supply time T2, the power supply apparatus 100 can output the second power P2 to the electronic device 200. If the time elapsed since the start timing of the second power P2 output by the power supply apparatus 100 is shorter than the power supply time T2, the power supply apparatus 100 cannot transmit any command to the electronic device 200.

The CPU 105 sets the power supply time T2 according to the following formula (4).

$$T 2 [ s ] \geq W [ W ] \times \frac{A [ s ]}{( P 2 [ W ] \times \frac{E [ \% ]}{100} - W [ W ]} \qquad ( 4 )$$

The operation power W in the formula (4) is a value indicating the operation power of the electronic device 200, which is included in the operation information of the electronic device 200 acquired from the electronic device 200. The communication time A in the formula (4) is the value set by the CPU 105 in step S209. The second power P2 in the formula (4) is the value set by the CPU 105 in step S216. The efficiency E in the formula (4) is a value indicating the power receiving efficiency of the electronic device 200 stored in the RAM 107.

If the setting of the power supply time T2 according to the formula (4) has been completed, the CPU 105 stores the setting value of the power supply time T2 in the RAM 107. In this case, the process of flowchart proceeds from step S217 to step S218.

In step S218, the CPU 105 stores a flag f2 in the RAM 107. The flag f2 is information indicating that the operation mode of the electronic device 200 is the predetermined mode and the battery 210 is in a fully charged state. When the CPU 105 detects the flag f2, the CPU 105 can determine that the electronic device 200 is performing an operation other than the charging without performing the charging. In this case, the process of flowchart proceeds from step S218 to step S215.

In step S219, the CPU 105 determines whether the battery 210 is in the fully-charged state with reference to the charging information of the electronic device 200 acquired from the electronic device 200. If the CPU 105 determines that the battery 210 is in the fully charged state (Yes in step S219), the process of flowchart proceeds from step S219 to step S223. If the CPU 105 determines that the battery 210 is not in the fully charged state (No in step S219), the process of flowchart proceeds from step S219 to step S220.

In step S220, the CPU 105 sets a second power P3 with reference to the charging information of the electronic device 200 acquired from the electronic device 200. In the present exemplary embodiment, the second power P3 is a value indicating the second power that can be output from the power supply apparatus 100 to the electronic device 200 in the power supply control process described below. The CPU 105 stores the setting value of the second power P3 in the RAM 107. The CPU 105 sets the second power P3 to be equal to or greater than the power value required for the electronic device 200. In this case, the process of flowchart proceeds from step S220 to step S221.

In step S221, the CPU 105 sets a power supply time T3. In the present exemplary embodiment, the power supply time T3 indicates a period of time during which the power supply apparatus 100 outputs the second power P3 to the electronic device 200 in the power supply control process.

If the time elapsed since the start timing of the second power P3 output by the power supply apparatus 100 is shorter than the power supply time T3, the power supply apparatus 100 can output the second power P3 to the electronic device 200. If the time elapsed since the start timing of the second power P3 output by the power supply apparatus 100 is shorter than the power supply time T3, the power supply apparatus 100 cannot transmit any command to the electronic device 200.

The CPU 105 sets the power supply time T3 according to the following formula (5).

$$T 3 [ s ] \geq W [ W ] \times \frac{A [ s ]}{( P 3 [ W ] \times \frac{E [ \% ]}{100} - W [ W ]} \qquad ( 5 )$$

The operation power W in formula (5) is a value indicating the operation power of the electronic device 200, which is included in the operation information of the electronic device 200 acquired from the electronic device 200. The communication time A in the formula (5) is the value set by the CPU 105 in step S209. The second power P3 in the formula (5) is the value set by the CPU 105 in step S220. The efficiency E in the formula (5) is a value indicating the power receiving efficiency of the electronic device 200 stored in the RAM 107.

If the setting of the power supply time T3 according to formula (5) has been completed, the CPU 105 stores the setting value of the power supply time T3 in the RAM 107. In this case, the process of flowchart proceeds from step S221 to step S222.

In step S222, the CPU 105 stores a flag f3 in the RAM 107. The flag f3 is information indicating that the operation mode of the electronic device 200 is not the predetermined mode and the battery 210 is not in a fully charged state. When the CPU 105 detects the flag f3, the CPU 105 can determine that the electronic device 200 is not performing an operation other than the charging while performing the charging. In this case, the process of flowchart proceeds from step S222 to step S215.

In step S223, the CPU 105 controls any one of the oscillator 101, the power generation unit 102, and the matching circuit 103 to stop supplying power to the electronic device 200. If the power generation unit 102 is currently generating the first power, the CPU 105 controls any one of the oscillator 101, the power generation unit 102, and the matching circuit 103 to stop outputting the first power.

Further, if the power generation unit 102 is currently generating the second power, the CPU 105 controls any one of the oscillator 101, the power generation unit 102, and the matching circuit 103 to stop outputting the second power. In this case, the CPU 105 terminates the processing of the flowchart illustrated in FIG. 2.

In the present exemplary embodiment, the predetermined mode is a mode in which the electronic device 200 performs an operation other than the charging and can be any mode other than the second charging mode, the shooting mode, the reproduction mode, and the communication mode.

In the present exemplary embodiment, if the determination result in step S219 is Yes, the power supply apparatus 100 does not output the first power and the second power. However, the process to be performed by the power supply apparatus 100 is not limited to the above-described example. For example, when the determination result in step S219 is Yes, the CPU 105 can continuously output the first power to the electronic device 200 without outputting the second power. In this case, the power supply apparatus 100 outputs the first power to the electronic device 200, although the power supply apparatus 100 does not perform the power supply control process in step S215. Therefore, the power supply apparatus 100 can communicate with the electronic device 200 via the power supply antenna 108 using a command.

(Power Supply Control Process)

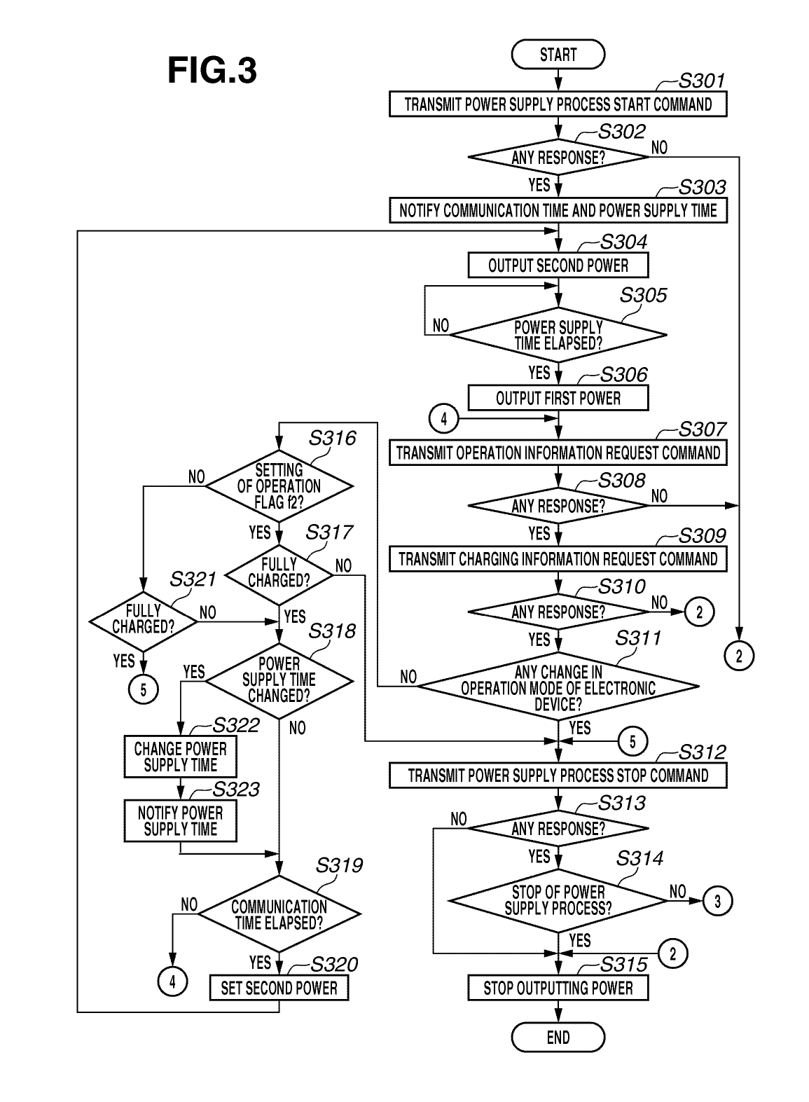

The power supply control process to be performed by the power supply apparatus 100 is described below with reference to a flowchart illustrated in FIG. 3. The power supply control process illustrated in FIG. 3 is an example process that can be performed by the power supply apparatus 100 (see step S215 in the setting process illustrated in FIG. 2). In the present exemplary embodiment, the CPU 105 controls the power supply control process illustrated in FIG. 3 by executing a computer program stored in the ROM 106.

In step S301, the CPU 105 controls the matching circuit 103 and the modulation and demodulation circuit 104 to transmit a fourth command to the electronic device 200. The fourth command is a command capable of notifying the electronic device 200 of starting process for supplying the second power to the electronic device 200. In this case, the process of flowchart proceeds from step S301 to step S302.

In step S302, the CPU 105 determines whether the modulation and demodulation circuit 104 has received a response replying to the fourth command having been transmitted to the electronic device 200 in step S301. If the CPU 105 determines that the modulation and demodulation circuit 104 has received the response replying to the fourth command (Yes in step S302), the process of flowchart proceeds from step S302 to step S303. If the CPU 105 determines that the modulation and demodulation circuit 104 has not received the response replying to the fourth command (No in step S302), the process of flowchart proceeds from step S302 to step S315.

In step S303, the CPU 105 controls the matching circuit 103 and the modulation and demodulation circuit 104 to transmit information indicating the communication time A stored in the RAM 107 and information indicating the power supply time stored in the RAM 107 to the electronic device 200. In this case, the process of flowchart proceeds from step S303 to step S304.

In this case, if the setting of the power supply time T1 by the CPU 105 (see step S213) has been completed, then in step S303, the CPU 105 controls the matching circuit 103 and the modulation and demodulation circuit 104 to transmit information indicating the power supply time T1 to the electronic device 200. If the setting of the power supply time T2 by the CPU 105 (see step S217) has been completed, then in step S303, the CPU 105 controls the matching circuit 103 and the modulation and demodulation circuit 104 to transmit information indicating the power supply time T2 to the electronic device 200. If the setting of the power supply time T3 by the CPU 105 (see step S221) has been completed, then in step S303, the CPU 105 controls the matching circuit 103 and the modulation and demodulation circuit 104 to transmit information indicating the power supply time T3 to the electronic device 200.

In step S304, the CPU 105 controls the oscillator 101, the power generation unit 102, and the matching circuit 103 to output the second power to an external device via the power supply antenna 108.

When the CPU 105 supplies the second power to the electronic device 200, the CPU 105 can transmit information indicating a second power value to the electronic device 200 via the power supply antenna 108. In the present exemplary embodiment, in the setting process illustrated in FIG. 2, the CPU 105 controls the power generation unit 102 to supply the set second power to the electronic device 200 via the power supply antenna 108.

If the second power P1 is set in step S212, then in step S304, the CPU 105 controls the oscillator 101, the power generation unit 102, and the matching circuit 103 to output the second power that corresponds to the second power P1 value to an external device. If the second power P2 is set in step S216, then in step S304, the CPU 105 controls the oscillator 101, the power generation unit 102, and the matching circuit 103 to output the second power that corresponds to the second power P2 value to an external device.

If the second power P3 is set in step S220, then in step S304, the CPU 105 controls the oscillator 101, the power generation unit 102, and the matching circuit 103 to output the second power that corresponds to the second power P3 value to an external device. Further, the CPU 105 controls the timer 109 to measure the time elapsed since the power supply apparatus 100 has output the second power. The time measured by the timer 109 is stored in the RAM 107. In this case, the process of flowchart proceeds from step S304 to step S305.

In step S305, the CPU 105 determines whether the time measured by the timer 109 has reached the power supply time having been set in the setting process illustrated in FIG. 2.

If the setting of the power supply time T1 (see step S213) has been completed, then in step S305, the CPU 105 determines whether the time measured by the timer 109 has reached the power supply time T1. If the setting of the power supply time T2 (see step S217) has been completed, then in step S305, the CPU 105 determines whether the time measured by the timer 109 has reached the power supply time T2. If the setting of the power supply time T3 (see step S221) has been completed, then in step S305, the CPU 105 determines whether the time measured by the timer 109 has reached the power supply time T3.

If the CPU 105 determines that the time measured by the timer 109 has reached the power supply time (Yes in step S305), the CPU 105 causes the timer 109 to stop measuring the time and deletes the time measured by the timer 109 from the RAM 107. In this case (Yes in step S305), the process of flowchart proceeds from step S305 to step S306. If the CPU 105 determines that the time measured by the timer 109 has not yet reached the power supply time (No in step S305), the process of flowchart returns from step S305 to step S305.

In step S306, the CPU 105 controls the oscillator 101, the power generation unit 102, and the matching circuit 103 to supply the first power to the electronic device 200. Further, the CPU 105 controls the timer 109 to measure the time elapsed since the power supply apparatus 100 has output the first power. The time measured by the timer 109 is stored in the RAM 107. In this case, the process of flowchart proceeds from step S306 to step S307.

In step S307, the CPU 105 controls the modulation and demodulation circuit 104 to transmit the second command to the electronic device 200. In this case, the process of flowchart proceeds from step S307 to step S308.

In step S308, the CPU 105 determines whether the modulation and demodulation circuit 104 has received the operation information of the electronic device 200, as a response replying to the second command transmitted to the electronic device 200 in step S307, to the electronic device 200. If the CPU 105 determines that the modulation and demodulation circuit 104 has received the operation information of the electronic device 200 from the electronic device 200 (Yes in step S308), the CPU 105 stores the operation information of the electronic device 200 in the RAM 107. In this case (Yes in step S308), the process of flowchart proceeds from step S308 to step S309. If the CPU 105 determines that the modulation and demodulation circuit 104 has not yet received the operation information of the electronic device 200 from the electronic device 200 (No in step S308), the process of flowchart proceeds from step S308 to step S315.

In step S309, the CPU 105 controls the modulation and demodulation circuit 104 to transmit the third command to the electronic device 200. In this case, the process of flowchart proceeds from step S309 to step S310.

In step S310, the CPU 105 determines whether the modulation and demodulation circuit 104 has received the charging information of the electronic device 200 as a response replying to the third command transmitted to the electronic device 200 in step S309. If the CPU 105 determines that the modulation and demodulation circuit 104 has received the charging information of the electronic device 200 from the electronic device 200 (Yes in step S310), the CPU 105 stores the operation information of the electronic device 200 in the RAM 107.

In this case (Yes in step S310), the process of flowchart proceeds from step S310 to step S311. If the CPU 105 determines that the modulation and demodulation circuit 104 has not yet received the charging information of the electronic device 200 from the electronic device 200 (No in step S310), the process of flowchart proceeds from step S310 to step S315.

In step S311, the CPU 105 determines whether the operation mode of the electronic device 200 has changed according to the operation information of the electronic device 200 acquired from the electronic device 200. The CPU 105 determines whether the operation mode of the electronic device 200 has changed by checking if there is any change in the information included in the operation information of the electronic device 200 stored in the RAM 107. If the CPU 105 determines that the operation mode of the electronic device 200 has changed (Yes in step S311), the process of flowchart proceeds from step S311 to step S312. If the CPU 105 determines that the operation mode of the electronic device 200 has not yet changed (No in step S311), the process of flowchart proceeds from step S311 to step S316.

In step S312, the CPU 105 controls the modulation and demodulation circuit 104 to transmit a fifth command to the electronic device 200. The fifth command is a command notifying the electronic device 200 of stopping supplying the second power to the electronic device 200. In this case, the process of flowchart proceeds from step S312 to step S313.

In step S313, the CPU 105 determines whether the modulation and demodulation circuit 104 has received a response replying to the fifth command transmitted to the electronic device 200 in step S312. If the CPU 105 determines that the modulation and demodulation circuit 104 has received the response replying to the fifth command (Yes in step S313), the process of flowchart proceeds from step S313 to step S314. If the CPU 105 determines that the modulation and demodulation circuit 104 has not yet received the response replying to the fifth command (No in step S313), the process of flowchart proceeds from step S313 to step S315.

In step S314, the CPU 105 determines whether to stop the process of supplying the power to the electronic device 200.

For example, the CPU 105 can check if any error has occurred in the power supply apparatus 100 to determine whether to stop the power supply process. If the CPU 105 determines that an error has occurred in the power supply apparatus 100, the CPU 105 determines to stop supplying the power to the electronic device 200 (Yes in step S314).

If the CPU 105 determines that no error has occurred in the power supply apparatus 100, the CPU 105 does not stop supplying the power to the electronic device 200 (No in step S314). For example, the error can be an error in the communication between the communication unit 112 and the communication unit 212 or can be an error relating to the power supply apparatus 100.

For example, the CPU 105 can check if the electronic device 200 is connected to the AC power source (not illustrated) in determining whether to stop the process of supplying the power to the electronic device 200. For example, the CPU 105 can check if a user performs an operation to instruct the power supply apparatus 100 to stop the power supply operation in determining whether to stop the process of supplying the power to the electronic device 200.

If the CPU 105 determines to stop supplying the power to the electronic device 200 (Yes in step S314), the process of flowchart proceeds from step S314 to step S315. If the CPU 105 determines to continue the process of supplying the power to the electronic device 200 (No in step S314), the process of flowchart proceeds from step S314 to step S205 of the setting process illustrated in FIG. 2.

In step S315, the CPU 105 controls any one of the oscillator 101, the power generation unit 102, and the matching circuit 103 to stop supplying the first power and the second power to an external device via the power supply antenna 108. In this case, the CPU 105 terminates the process of the flowchart illustrated in FIG. 3.

In step S316, the CPU 105 determines whether the operation flag f2 is set in the RAM 107. If the operation flag is set to f1 in step S214, then in step S316, the CPU 105 determines that the operation flag f2 is not set in the RAM 107. If the operation flag is set to f2 in step S218, then in step S316, the CPU 105 determines that the operation flag f2 is set in the RAM 107. If the operation flag is set to f3 in step S222, then in step S316, the CPU 105 determines that the operation flag f2 is not set in the RAM 107.

If the CPU 105 determines that the operation flag f2 is not set in the RAM 107 (No in step S316), the process of flowchart proceeds from step S316 to step S321. If the CPU 105 determines that the operation flag f2 is set in the RAM 107 (Yes in step S316), the process of flowchart proceeds from step S316 to step S317.

In step S317, the CPU 105 determines whether the battery 210 is in a fully-charged state based on the charging information of the electronic device 200 acquired from the electronic device 200. If the CPU 105 determines that the battery 210 is in the fully charged state (Yes in step S317), the process of flowchart proceeds from step S317 to step S318. If the CPU 105 determines that the battery 210 is not in the fully charged state (No in step S317), the process of flowchart proceeds from step S317 to step S312.

In step S318, the CPU 105 determines whether to change the power supply time having been set in the setting process illustrated in FIG. 2. Further, the CPU 105 can check if a power supply time change instruction is input to the power supply apparatus 100 in determining whether to change the power supply time. The power supply time change instruction can be input via the operation unit 115 or can be received from the electronic device 200. The power supply time change instruction is included in the information indicating the setting value of the power supply time. In the present exemplary embodiment, the setting value of the power supply time included in the power supply time change instruction is power supply time T4.

If the CPU 105 determines to change the power supply time (Yes in step S318), the process of flowchart proceeds from step S318 to step S322. If the CPU 105 determines to hold the power supply time (No in step S318), the process of flowchart proceeds from step S318 to step S319.

In step S319, the CPU 105 determines whether the time measured by the timer 109 has reached the communication time A having been set in step S209 of the setting process illustrated in FIG. 2. If the CPU 105 determines that the time measured by the timer 109 has reached the communication time A (Yes in step S319), the CPU 105 causes the timer 109 to stop measuring the time and deletes the time measured by the timer 109 from the RAM 107. In this case (Yes in step S319), the process of flowchart proceeds from step S319 to step S320. If the CPU 105 determines that the time measured by the timer 109 has not yet reached the communication time A (No in step S319), the process of flowchart returns from step S319 to step S307.

In step S320, the CPU 105 determines the setting value of the second power stored in the RAM 107 according to the charging information of the electronic device 200 acquired from the electronic device 200.

For example, the CPU 105 detects the remaining capacity of the battery 210 with reference to the charging information of the electronic device 200 acquired in step S310, and determines the setting value of the second power according to the remaining capacity of the battery 210.

For example, in a case where the second power P1 has been output from the power supply apparatus 100 in step S304, if the remaining capacity of the battery 210 is less than a predetermined value, the CPU 105 does not change the second power P1. Further, in the case where the second power P1 has been output from the power supply apparatus 100 in step S304, if the remaining capacity of the battery 210 is equal to or greater than the predetermined value, the CPU 105 sets the second power to be a value smaller than the second power P1.

Further, for example, the CPU 105 can determine whether trickle charging for the battery 210 is currently performed or rapid charging for the battery 210 is currently performed with reference to the charging information of the electronic device 200 acquired from the electronic device 200. If the rapid charging for the battery 210 is currently performed, the CPU 105 can set the second power to be a value greater than the second power in the case where the trickle charging for the battery 210 is performed. For example, in the case where the second power P1 has been output from the power supply apparatus 100 in step S304, if the electronic device 200 is performing the trickle charging for the battery 210, the CPU 105 does not change the setting value of the second power.

Further, in the case where the second power P1 has been output from the power supply apparatus 100 in step S304, if the electronic device 200 is performing the rapid charging for the battery 210, the CPU 105 sets the second power to be a value greater than the second power P1. If the setting of the setting value of the second power is accomplished, the process of flowchart returns from step S320 to step S304.

When the CPU 105 performs the process in step S304 again, the CPU 105 controls the oscillator 101, the power generation unit 102, and the matching circuit 103 to notify information indicating the second power value having been set in step S320 to the electronic device 200 via the power supply antenna 108.

In step S321, the CPU 105 determines whether the battery 210 is in a fully-charged state based on the charging information of the electronic device 200 acquired from the electronic device 200. If the CPU 105 determines that the battery 210 is in the fully charged state (Yes in step S321), the process of flowchart proceeds from step S321 to step S312. If the CPU 105 determines that the battery 210 is not in the fully charged state (No in step S321), the process of flowchart proceeds from step S321 to step S318.

In step S322, the CPU 105 changes the power supply time set in the RAM 107 to the power supply time T4 with reference to the information indicating power supply time T4 included in the power supply time change instruction. In this case, the process of flowchart proceeds from step S322 to step S323.

In step S323, the CPU 105 controls the matching circuit 103 and the modulation and demodulation circuit 104 to transmit information indicating the power supply time T4 having been changed in step S322 to the electronic device 200. In this case, the process of flowchart proceeds from step S323 to step S319.

In the present exemplary embodiment, in step S322, the CPU 105 changes the power supply time set in the RAM 107 to the power supply time T4 with reference to information indicating the setting value of the power supply time T4 included in the power supply time change instruction. However, the process to be performed in step S322 is not limited to the above-described example.

For example, if the power supply time T4 is longer than the power supply time set in the RAM 107, the CPU 105 changes the power supply time set in the RAM 107 to the power supply time T4 according to the power supply time change instruction. When the power supply time T4 included in the power supply time change instruction coincides with the setting value of the power supply time stored in the RAM 107, the CPU 105 does not change the power supply time stored in the RAM 107.

When the power supply time T4 is shorter than the power supply time set in the RAM 107, the CPU 105 may determine whether to change the power supply time set in the RAM 107 with reference to the operation information of the electronic device 200.

In this case, if it is determined that the operation mode of the electronic device 200 is the first charging mode based on the operation information of the electronic device 200, the CPU 105 changes the power supply time set in the RAM 107 to the power supply time T4 according to the power supply time change instruction. Further, in this case, if it is determined that the operation mode of the electronic device 200 is an operation mode other than the first charging mode based on the operation information of the electronic device 200, the CPU 105 does not change the power supply time stored in the RAM 107.

In step S311 of the power supply control process illustrated in FIG. 3, the CPU 105 determines whether the operation mode of the electronic device 200 has been changed. If the operation mode of the electronic device 200 has been changed (Yes in step S311), the CPU 105 performs the processes sequentially in step S312, step S313, and step S314. If the CPU 105 determines to continue the power supply process (No in step S314), the CPU 105 performs the processes in step S205 to step S223.

In this case, if the operation mode of the electronic device 200 has been changed, the power supply apparatus 100 can set the second power and the power supply time again by performing the processes in step S205 to step S223. Therefore, according to the operation mode of the electronic device 200, the power supply apparatus 100 can output an appropriate second power and can set an appropriate power supply time.

Further, in step S317 of the power supply control process illustrated in FIG. 3, the CPU 105 determines whether the battery 210 is in a fully-charged state when it is determined that the electronic device 200 is in the predetermined operation mode and the battery 210 is in the fully-charged state.

If the battery 210 of the electronic device 200 is not in the fully-charged state (No in step S317), the CPU 105 performs the processes in step S312, step S313, and step S314. If the CPU 105 determines to continue the power supply process (No in step S314), the CPU 105 performs the processes in step S205 to step S223 again. In this case, if the battery 210 is not in the fully charged state, the power supply apparatus 100 can set the second power and the power supply time again by performing the processing in step S205 to step S223. Therefore, according to the state of the battery 210 of the electronic device 200, the power supply apparatus 100 can output an appropriate second power and can set an appropriate power supply time.

Further, in step S321 of the power supply control process illustrated in FIG. 3, the CPU 105 determines whether the battery 210 of the electronic device 200 is in the fully charged state. If it is determined that the battery 210 of the electronic device 200 is in the fully charged state (Yes in step S321), the CPU 105 performs the processes in step S312, step S313, and step S314. If the CPU 105 determines to continue the power supply process (No in step S314), the CPU 105 performs the processes in step S205 to step S223 again.

In this case, if the battery 210 is in the fully-charged state, the power supply apparatus 100 can set the second power and the power supply time again by performing the processes in step S205 to step S223. Therefore, according to the state of the battery 210 of the electronic device 200, the power supply apparatus 100 can output an appropriate second power and can set an appropriate power supply time.

In step S311, the CPU 105 determines whether the operation mode of the electronic device 200 has been changed. In this case, the CPU 105 can check if the operation mode of the electronic device 200 has been changed from the predetermined mode to a different mode.

(Command Reception Process)

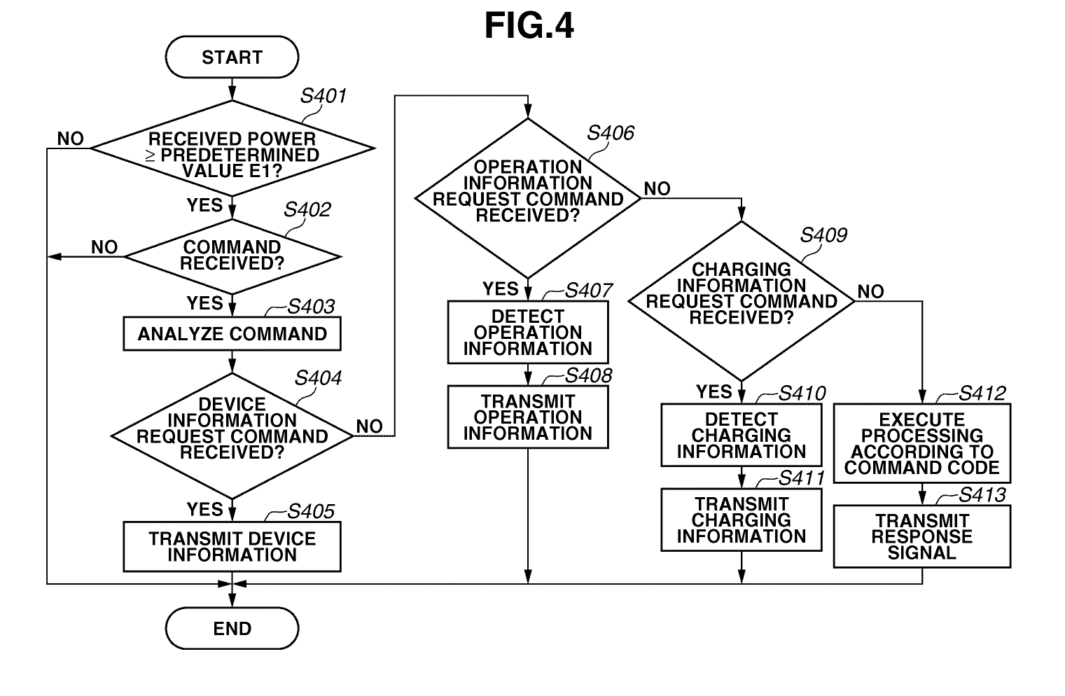

The command reception process to be performed by the electronic device 200 is described below with reference to a flowchart illustrated in FIG. 4. The command reception process illustrated in FIG. 4 is an example process that can be performed by the electronic device 200 when the power supply apparatus 100 supplies the first power. To realize the command reception process illustrated in FIG. 4, the CPU 205 executes a computer program loaded from the ROM 206. Alternatively, the command reception process illustrated in FIG. 4 can be performed periodically.

In step S401, the CPU 205 determines whether the power received by the electronic device 200 is equal to or greater than a predetermined value E1. The CPU 205 detects the power received by the electronic device 200 based on the voltage information and the current information supplied from the current and voltage detection unit 214. The predetermined value E1 is a value to be referred to when the electronic device 200 checks if the power supply apparatus 100 is outputting the first power.

The predetermined value E1 is stored beforehand in the ROM 206. If the CPU 205 determines that the received power is equal to or greater than the predetermined value E1 (Yes in step S401), the CPU 205 determines that the power supply apparatus 100 is outputting the first power. In this case (Yes in step S401), the process of flowchart proceeds from step S401 to step S402. If the CPU 205 determines that the received power is less than the predetermined value E1 (No in step S401), the CPU 205 determines that the power supply apparatus 100 is not outputting the first power. In this case (No in step S401), the CPU 205 terminates the process of the flowchart illustrated in FIG. 4.

In step S402, the CPU 205 determines whether the modulation and demodulation circuit 204 has received a command from the power supply apparatus 100. If the CPU 205 determines that the modulation and demodulation circuit 204 has not received any command from the power supply apparatus 100 (No in step S402), the CPU 205 terminates the process of the flowchart illustrated in FIG. 4. If the CPU 205 determines that the modulation and demodulation circuit 204 has received a command from the power supply apparatus 100 (Yes in step S402), the process of flowchart proceeds from step S402 to step S403.

In step S403, the CPU 205 controls the modulation and demodulation circuit 204 to analyze the command transmitted from the power supply apparatus 100 to the modulation and demodulation circuit 204. In this case, the process of flowchart proceeds from step S403 to step S404. If the modulation and demodulation circuit 204 has completed the analysis on the command, the modulation and demodulation circuit 204 supplies an analysis result to the CPU 205.

In step S404, the CPU 205 determines whether the command received by the modulation and demodulation circuit 204 is the first command based on the analysis result supplied from the modulation and demodulation circuit 204. If the CPU 205 determines that the command received by the modulation and demodulation circuit 204 is not the first command (No in step S404), the process of flowchart proceeds from step S404 to step S406. If the CPU 205 determines that the command received by the modulation and demodulation circuit 204 is the first command (Yes in step S404), the process of flowchart proceeds from step S404 to step S405.

In step S405, the CPU 205 controls the modulation and demodulation circuit 204 to perform load modulation to transmit the device information of the electronic device 200 stored in the ROM 206, as a response replying to the first command, to the power supply apparatus 100. In this case, the CPU 205 terminates the process of the flowchart illustrated in FIG. 4.

In step S406, the CPU 205 determines whether the command received by the modulation and demodulation circuit 204 is the second command based on the analysis result supplied from the modulation and demodulation circuit 204. If the CPU 205 determines that the command received by the modulation and demodulation circuit 204 is not the second command (No in step S406), the process of flowchart proceeds from step S406 to step S409. If the CPU 205 determines that the command received by the modulation and demodulation circuit 204 is the second command (Yes in step S406), the process of flowchart proceeds from step S406 to step S407.

In step S407, the CPU 205 detects the operation information of the electronic device 200. More specifically, the CPU 205 detects a presently set operation mode of the electronic device 200 and detects the operation information of the electronic device 200 by detecting the operation power W that corresponds to the presently set operation mode. The operation information detected by the CPU 205 is stored in the RAM 207. In this case, the process of flowchart proceeds from step S407 to step S408.

In step S408, the CPU 205 controls the matching circuit 202 and the modulation and demodulation circuit 204 to perform load modulation to transmit the operation information of the electronic device 200 stored in the RAM 207, as a response replying to the second command, to the power supply apparatus 100. In this case, the CPU 205 terminates the process of the flowchart illustrated in FIG. 4.

In step S409, the CPU 205 determines whether the command received by the modulation and demodulation circuit 204 is the third command based on the analysis result supplied from the modulation and demodulation circuit 204. If the CPU 205 determines that the command received by the modulation and demodulation circuit 204 is not the third command (No in step S409), the process of flowchart proceeds from step S409 to step S412. If the CPU 205 determines that the command received by the modulation and demodulation circuit 204 is the third command (Yes in step S409), the process of flowchart proceeds from step S409 to step S410.

In step S410, the CPU 205 controls the charging control unit 209 to detect the charging information of the electronic device 200. The CPU 205 stores the charging information of the electronic device 200 detected by the charging control unit 209 in the RAM 207. In this case, the process of flowchart proceeds from step S410 to step S411.

In step S411, the CPU 205 controls the modulation and demodulation circuit 204 to perform load modulation to transmit the charging information of the electronic device 200, as a response replying to the third command, to the power supply apparatus 100. In this case, the CPU 205 terminates the process of the flowchart illustrated in FIG. 4.

In step S412, the CPU 205 performs a process that corresponds to the command code obtained from the analysis result supplied from the modulation and demodulation circuit 204. In this case, the process of flowchart proceeds from step S412 to step S413.

In step S413, the CPU 205 controls the modulation and demodulation circuit 204 to perform load modulation to transmit a response signal that corresponds to the command code obtained from the analysis result supplied from the modulation and demodulation circuit 204 to the power supply apparatus 100. In this case, the CPU 205 terminates the process of the flowchart illustrated in FIG. 4.

(First Charging Process)

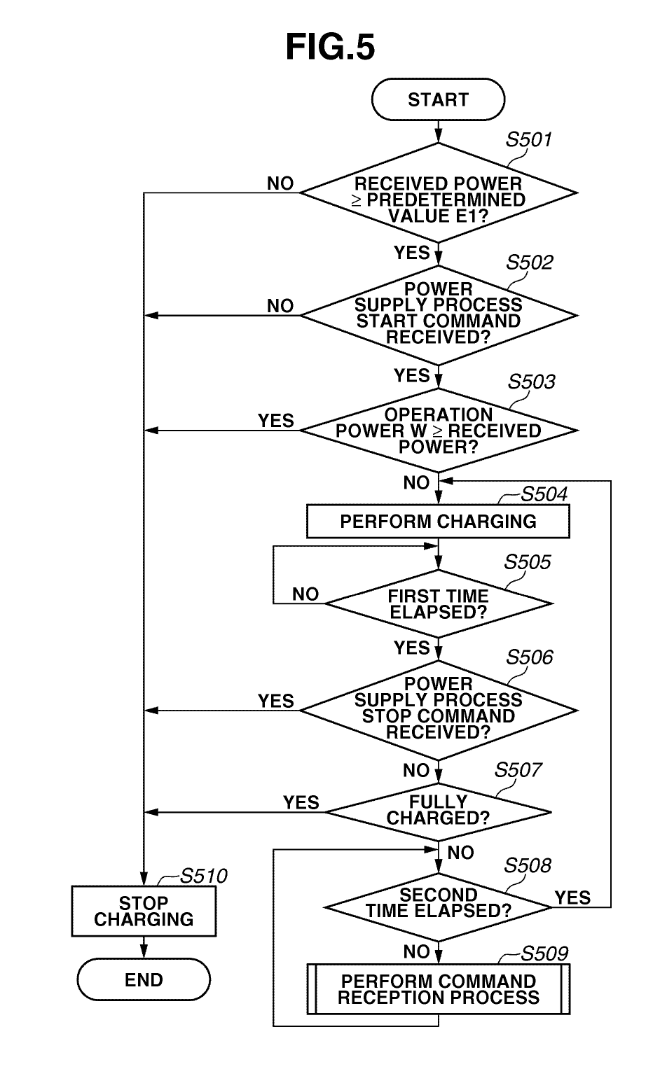

The first charging process to be performed by the electronic device 200 is described below with reference to a flowchart illustrated in FIG. 5. The first charging process illustrated in FIG. 5 is an example process that can be performed by the electronic device 200 when the operation mode of the electronic device 200 is set to the first charging mode. In this case, the electronic device 200 does not supply power to the communication unit 212, the imaging unit 213, the recording unit 215, and the recording medium 215a. Further, the communication unit 212, the imaging unit 213, the recording unit 215, and the recording medium 215a do not perform any specific operation. To realize the first charging process illustrated in FIG. 5, the CPU 205 executes a computer program loaded from the ROM 206.

In step S501, the CPU 205 determines whether the power received by the electronic device 200 is equal to or greater than the predetermined value E1. If the CPU 205 determines that the received power is equal to or greater than the predetermined value E1 (Yes in step S501), the process of flowchart proceeds from step S501 to step S502. If the CPU 205 determines that the power received by the electronic device 200 is less than the predetermined value E1 (No in step S501), the process of flowchart proceeds from step S501 to step S510.

In step S502, the CPU 205 determines whether the modulation and demodulation circuit 204 has received the fourth command from the power supply apparatus 100. If the CPU 205 determines that the modulation and demodulation circuit 204 has not yet received the fourth command from the power supply apparatus 100 (No in step S502), the process of flowchart proceeds from step S502 to step S510. If the CPU 205 determines that the modulation and demodulation circuit 204 has received the fourth command from the power supply apparatus 100 (Yes in step S502), the process of flowchart proceeds from step S502 to step S503. In this case (Yes in step S502), the CPU 205 controls the modulation and demodulation circuit 204 to perform load modulation to transmit a response signal that corresponds to the fourth command to the power supply apparatus 100.

In step S503, the CPU 205 determines whether the operation power W of the electronic device 200 is equal to or greater than the received power. The CPU 205 detects the power received by the electronic device 200 based on the voltage information and the current information supplied from the current and voltage detection unit 214. Further, the CPU 205 detects the operation power W required to operate the electronic device 200. For example, the operation power W in step S503 includes the power to be supplied to the battery and the power to be supplied to the charging control unit 209.

If the CPU 205 determines that the operation power W is equal to or greater than the received power (Yes in step S503), the process of flowchart proceeds from step S503 to step S510. If the CPU 205 determines that the operation power W is less than the received power (No in step S503), the process of flowchart proceeds from step S503 to step S504.

In step S504, the CPU 205 supplies the power received from the power supply apparatus 100 to the charging control unit 209 and the battery 210 and causes the charging control unit 209 to charge the battery 210. Further, the CPU 105 controls the timer 211 to measure the time elapsed since the charging control unit 209 started the charging of the battery 210. The time measured by the timer 211 is stored in the RAM 207. In this case, the process of flowchart proceeds from step S504 to step S505.

In step S505, the CPU 105 determines whether the time measured by the timer 211 has reached the first time. The first time is a time that can be set according to the power supply time notified from the power supply apparatus 100. The first time is equal to or longer than the power supply time.

For example, when the power supply time having been set by the CPU 105 is T1, the CPU 205 sets the first time to a predetermined time that is equal to or greater than the power supply time T1. Further, for example, when the power supply time having been set by the CPU 105 is T2, the CPU 205 sets the first time to a predetermined time that is equal to or greater than the power supply time T2. For example, when the power supply time having been set by the CPU 105 is T3, the CPU 205 sets the first time to a predetermined time that is equal to or greater than the power supply time T3.

If the CPU 205 determines that the time measured by the timer 211 has reached the first time (Yes in step S505), the CPU 205 causes the timer 211 to stop measuring the time and deletes the time measured by the timer 211 from the RAM 207. Further, the CPU 205 controls the timer 211 to measure the time elapsed since the elapse of the first time. In this case (Yes in step S505), the process of flowchart proceeds from step S505 to step S506. If the CPU 205 determines that the time measured by the timer 211 has not yet reached the first time (No in step S505), the process of flowchart returns from step S505 to step S505.

In step S506, the CPU 205 determines whether the modulation and demodulation circuit 204 has received the fifth command from the power supply apparatus 100. If the CPU 205 determines that the modulation and demodulation circuit 204 has not yet received the fifth command from the power supply apparatus 100 (No in step S506), the process of flowchart proceeds from step S506 to step S507. In this case (Yes in step S506), the CPU 205 controls the modulation and demodulation circuit 204 to perform load modulation to transmit a response signal that corresponds to the fifth command to the power supply apparatus 100. If the CPU 205 determines that the modulation and demodulation circuit 204 has received the fifth command from the power supply apparatus 100 (Yes in step S506), the process of flowchart proceeds from step S506 to step S510.

In step S507, the CPU 205 determines whether the battery 210 is in a fully-charged state based on the remaining capacity information detected by the charging control unit 209. If the CPU 205 determines that the battery 210 is in the fully charged state (Yes in step S507), the process of flowchart proceeds from step S507 to step S510. If the CPU 205 determines that the battery 210 is not in the fully charged state (No in step S507), the process of flowchart proceeds from step S507 to step S508.

In step S508, the CPU 105 determines whether the time measured by the timer 211 has reached the second time. The second time is a time that can be set according to the communication time A notified from the power supply apparatus 100. The second time is equal to or longer than the communication time A.

If the CPU 205 determines that the time measured by the timer 211 has not reached the second time (No in step S508), the process of flowchart proceeds from step S508 to step S509. If the CPU 205 determines that the time measured by the timer 211 has reached the second time (Yes in step S508), the CPU 205 causes the timer 211 to stop measuring the time and deletes the time measured by the timer 211 from the RAM 207. In this case (Yes in step S508), the process of flowchart returns from step S508 to step S504. When the process returns from step S508 to step S504, the CPU 205 causes the timer 211 to measure the time. In this case, the time measured by the timer 211 is compared with the first time again in step S505.

In step S509, the CPU 205 performs a command reception process. The command reception process to be performed in step S509 is similar to the process illustrated in FIG. 4. If the command reception process has been completed, the process of flowchart returns from step S509 to step S508.

In step S510, the CPU 205 controls the charging control unit 209 to stop the charging of the battery 210. In this case, the CPU 205 terminates the process of the flowchart illustrated in FIG. 5.

(Second Charging Process)

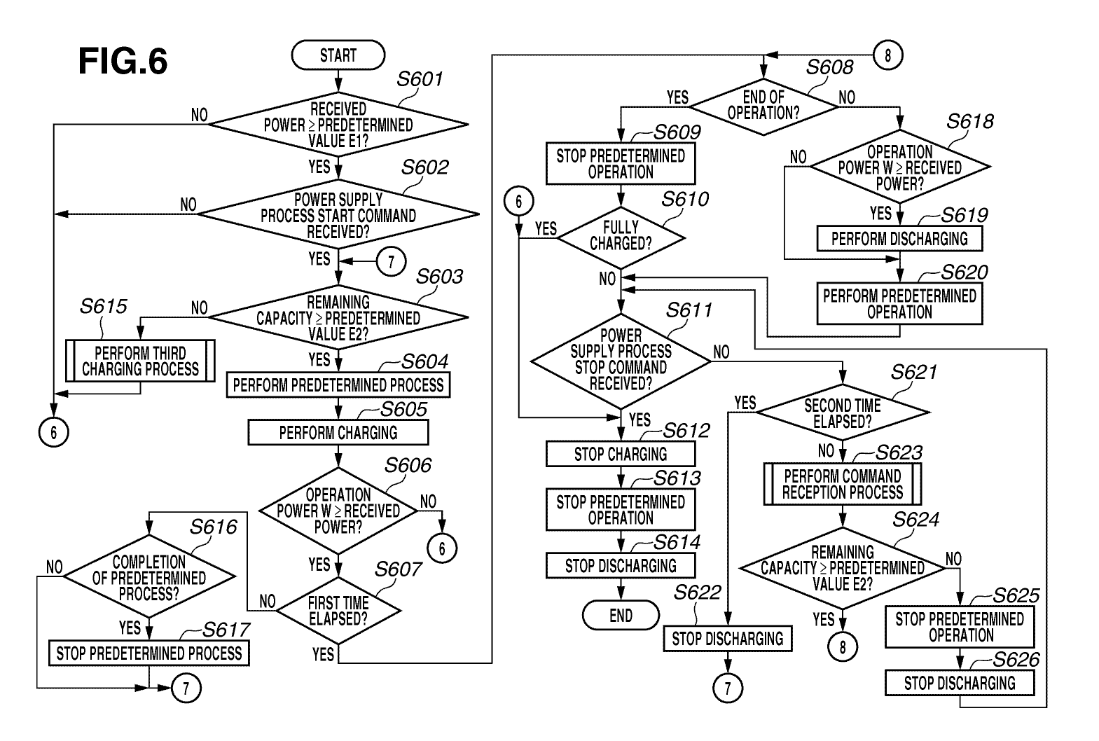

The second charging process to be performed by the electronic device 200 is described below with reference to a flowchart illustrated in FIG. 6. The second charging process illustrated in FIG. 6 is an example process that can be performed by the electronic device 200 when the operation mode of the electronic device 200 is set to any one of the second charging mode, the shooting mode, the reproduction mode, and the communication mode.

The power received from the power supply apparatus 100 can be supplied to the regulator 208, the CPU 205, the ROM 206, the RAM 207, and the timer 211. Further, in this case, the power received from the power supply apparatus 100 can be also supplied to the modulation and demodulation circuit 204, the matching circuit 202, the rectifying and smoothing circuit 203, the operation unit 216, and the current and voltage detection unit 214.

To realize the second charging process illustrated in FIG. 6, the CPU 205 executes a computer program loaded from the ROM 206. The second charging process illustrated in FIG. 6 includes process contents that are similar to those of the first charging process illustrated in FIG. 5, although their descriptions are not repeated.

In step S601, similar to step S501, the CPU 205 determines whether the received power is equal to or greater than the predetermined value E1. If the CPU 205 determines that the received power is equal to or greater than the predetermined value E1 (Yes in step S601), the process of flowchart proceeds from step S601 to step S602. If the CPU 205 determines that the received power is less than the predetermined value E1 (No in step S601), the process of flowchart proceeds from step S601 to step S612.

In step S602, the CPU 205 determines whether the modulation and demodulation circuit 204 has received the fourth command from the power supply apparatus 100. If the CPU 205 determines that the modulation and demodulation circuit 204 has not yet received the fourth command from the power supply apparatus 100 (No in step S602), the process of flowchart proceeds from step S602 to step S612.

If the CPU 205 determines that the modulation and demodulation circuit 204 has received the fourth command from the power supply apparatus 100 (Yes in step S602), the process of flowchart proceeds from step S602 to step S603. In this case (Yes in step S602), the CPU 205 controls the modulation and demodulation circuit 204 to perform load modulation to transmit a response signal that corresponds to the fourth command to the power supply apparatus 100.

In step S603, the CPU 205 determines whether the remaining capacity of the battery 210 is equal to or greater than a predetermined value E2. The predetermined value E2 is a value to be referred to when the CPU 205 determines whether to perform a third charging process. The predetermined value E2 is a threshold that can be applied to the remaining capacity of the battery 210. If the CPU 205 determines that the remaining capacity of the battery 210 is equal to or greater than the predetermined value E2 (Yes in step S603), the process of flowchart proceeds from step S603 to step S604. If the CPU 205 determines that the remaining capacity of the battery 210 is less than the predetermined value E2 (No in step S603), the process of flowchart proceeds from step S603 to step S615.

In step S604, the CPU 205 performs a predetermined process according to the operation mode of the electronic device 200. Further, in this case, the CPU 205 determines whether to supply the received power to the communication unit 212, the imaging unit 213, the recording unit 215, and the recording medium 215a according to the operation mode of the electronic device 200.

In a case where the operation mode of the electronic device 200 is set to the shooting mode, the CPU 205 controls the regulator 208 to supply the power received from the power supply apparatus 100 to the imaging unit 213, the recording unit 215, and the recording medium 215a. In this case, the CPU 205 controls the regulator 208 to prevent the power received from the power supply apparatus 100 from being supplied to the communication unit 212. Further, the CPU 205 controls the imaging unit 213, the recording unit 215, and the recording medium 215a in such a way as to perform a process according to a user instruction input via the operation unit 216.

In a case where the operation mode of the electronic device 200 is the reproduction mode, the CPU 205 controls the regulator 208 to supply the power received from the power supply apparatus 100 to the recording unit 215 and the recording medium 215a. In this case, the CPU 205 controls the regulator 208 to prevent the power received from the power supply apparatus 100 from being supplied to the imaging unit 213 and the communication unit 212. Further, the CPU 205 controls the recording unit 215 and the recording medium 215a to perform a process according to a user instruction input via the operation unit 216.

In a case where the operation mode of the electronic device 200 is the communication mode, the CPU 205 controls the regulator 208 to supply the power received from the power supply apparatus 100 to the communication unit 212, the recording unit 215, and the recording medium 215a. In this case, the CPU 205 controls the regulator 208 to prevent the power received from the power supply apparatus 100 from being supplied to the imaging unit 213. Further, the CPU 205 controls the communication unit 212, the recording unit 215, and the recording medium 215a to perform a process according to a user instruction input via the operation unit 216. In this case, the process of flowchart proceeds from step S604 to step S605.

In step S605, the CPU 205 controls the regulator 208 to supply the power received from the power supply apparatus 100 to the charging control unit 209 and the battery 210. Further, the CPU 205 controls the charging control unit 209 to perform the charging of the battery 210. Further, the CPU 205 controls the timer 211 to measure the time elapsed since the charging control unit 209 started the charging of the battery 210. The time measured by the timer 211 is stored in the RAM 207. In this case, the process of flowchart proceeds from step S605 to step S606. Alternatively, if it is detected that the battery 210 is in a fully charged state, the CPU 205 can skip the process of step S605.

In step S606, the CPU 205 determines whether the operation power W of the electronic device 200 is equal to or greater than the received power.

For example, the operation power W in step S606 includes the power to be used to charge the battery 210 and the power to be supplied to the communication unit 212, the recording unit 215, and the recording medium 215a, when the operation mode of the electronic device 200 is the communication mode and the charging has been performed in step S605.

For example, the operation power W in step S606 includes the power to be supplied to the communication unit 212, the recording unit 215, and the recording medium 215a, when the operation mode of the electronic device 200 is the communication mode and the charging is not yet performed in step S605.

For example, the operation power W in step S606 includes the power to be used to charge the battery 210 and the power to be supplied to the imaging unit 213, the recording unit 215, and the recording medium 215a, when the operation mode of the electronic device 200 is the shooting mode and the charging has been performed in step S605.

For example, the operation power W in step S606 includes the power to be supplied to the imaging unit 213, the recording unit 215, and the recording medium 215a, when the operation mode of the electronic device 200 is the shooting mode and the charging is not yet performed in step S605. The above-described description with respect to the operation power W in step S606 is similarly applicable to the case where the operation mode of the electronic device 200 is the reproduction mode.

If the CPU 205 determines that the operation power W is equal to or greater than the received power (Yes in step S606), the process of flowchart proceeds from step S606 to step S607. If the CPU 205 determines that the operation power W is less than the received power (No in step S606), the process of flowchart proceeds from step S606 to step S612.

In step S607, similar to step S505, the CPU 205 determines whether the time measured by the timer 211 has reached the first time. If the CPU 205 determines that the time measured by the timer 211 has reached the first time (Yes in step S607), the CPU 205 causes the timer 211 to stop measuring the time and deletes the time measured by the timer 211 from the RAM 207. Further, the CPU 205 controls the timer 211 in such a way as to measure the time elapsed since the elapse of the first time. In this case (Yes in step S607), the process of flowchart proceeds from step S607 to step S608. If the CPU 205 determines that the time measured by the timer 211 has not yet reached the first time (No in step S607), the process of flowchart proceeds from step S607 to step S616.

In step S608, the CPU 205 determines whether the predetermined process (see step S604) has been completed. If the CPU 205 determines that the predetermined process has been completed (Yes in step S608), the process of flowchart proceeds from step S608 to step S609. If the CPU 205 determines that the predetermined process is not yet completed (No in step S608), the process of flowchart proceeds from step S608 to step S618.

In step S609, the CPU 205 controls the electronic device 200 to stop the predetermined process (performed in step S604).

When the operation mode of the electronic device 200 is the shooting mode, the CPU 205 controls the imaging unit 213, the recording unit 215, and the recording medium 215a in such a way as to stop their operations. Further, in this case, the CPU 205 can control the regulator 208 to stop supplying the received power to the imaging unit 213, the recording unit 215, and the recording medium 215a.

When the operation mode of the electronic device 200 is the reproduction mode, the CPU 205 controls the recording unit 215 and the recording medium 215a to stop their operations. Further, in this case, the CPU 205 can control the regulator 208 to stop supplying the received power to the recording unit 215 and the recording medium 215a.

When the operation mode of the electronic device 200 is the communication mode, the CPU 205 controls the communication unit 212, the recording unit 215, and the recording medium 215a to stop their operations. Further, in this case, the CPU 205 can control the regulator 208 to stop supplying the received power to the communication unit 212, the recording unit 215, and the recording medium 215a.

When the above-described predetermined process stop operation has been completed, the process of flowchart proceeds from step S609 to step S610.

In step S610, similar to step S507, the CPU 205 determines whether the battery 210 is in a fully charged state. If the CPU 205 determines that the battery 210 is in the fully charged state (Yes in step S610), the process of flowchart proceeds from step S610 to step S612. If the CPU 205 determines that the battery 210 is not in the fully charged state (No in step S610), the process of flowchart proceeds from step S610 to step S611.

In step S611, the CPU 205 determines whether the modulation and demodulation circuit 204 has received the fifth command from the power supply apparatus 100. If the CPU 205 determines that the modulation and demodulation circuit 204 has not yet received the fifth command from the power supply apparatus 100 (No in step S611), the process of flowchart proceeds from step S611 to step S621. In this case (Yes in step S611), the CPU 205 controls the modulation and demodulation circuit 204 to perform load modulation to transmit a response signal that corresponds to the fifth command the power supply apparatus 100. If the CPU 205 determines that the modulation and demodulation circuit 204 has received the fifth command from the power supply apparatus 100 (Yes in step S611), the process of flowchart proceeds from step S611 to step S612.

In step S612, similar to step S510, the CPU 205 controls the charging control unit 209 to stop the charging of the battery 210. In this case, the process of flowchart proceeds from step S612 to step S613.

In step S613, similar to step S609, the CPU 205 controls the electronic device 200 to stop the predetermined process that is started in step S604. When the predetermined process stop operation has been completed, the process of flowchart proceeds from step S613 to step S614.

In step S614, the CPU 205 stops the discharging of the battery 210. In this case, the CPU 205 terminates the process of the flowchart illustrated in FIG. 6. If the CPU 205 does not discharge the battery 210, the CPU 205 can skip the process of step S614 and terminate the second charging process.

In step S615, the CPU 205 performs the third charging process, as described in detail below. When the CPU 205 has completed the third charging process, the process of flowchart proceeds from step S615 to step S612.

In step S616, similar to step S608, the CPU 205 determines whether the predetermined process (see step S604) has been completed. If the CPU 205 determines that the predetermined process has been completed (Yes in step S616), the process of flowchart proceeds from step S616 to step S617. If the CPU 205 determines that the predetermined process is not yet completed (No in step S616), the process of flowchart returns from step S616 to step S603.

In step S617, similar to step S609, the CPU 205 controls the electronic device 200 to stop the predetermined process that is started in step S604. When the predetermined process stop operation has been completed, the process of flowchart returns from step S617 to step S603.

In step S618, similar to step S606, the CPU 205 determines whether the operation power W of the electronic device 200 is equal to or greater than the received power. If the CPU 205 determines that the operation power W is equal to or greater than the received power (Yes in step S618), the process of flowchart proceeds from step S618 to step S619. If the CPU 205 determines that the operation power W is less than the received power (No in step S618), the process of flowchart proceeds from step S618 to step S620.

In step S619, the CPU 205 controls the charging control unit 209 to stop the charging of the battery 210 and discharge the battery 210. Further, in this case, the CPU 205 determines whether to supply the power discharged from the battery 210 to the communication unit 212, the imaging unit 213, the recording unit 215, and the recording medium 215a according to the operation mode of the electronic device 200.

When the operation mode of the electronic device 200 is the shooting mode, the CPU 205 controls the regulator 208 to supply the power discharged from the battery 210 to the imaging unit 213, the recording unit 215, and the recording medium 215a. In this case, the CPU 205 controls the regulator 208 to prevent the power discharged from the battery 210 from being supplied to the communication unit 212.

When the operation mode of the electronic device 200 is the reproduction mode, the CPU 205 controls the regulator 208 to supply the power discharged from the battery 210 to the recording unit 215 and the recording medium 215a. In this case, the CPU 205 controls the regulator 208 to prevent the power discharged from the battery 210 from being supplied to the imaging unit 213 and the communication unit 212.

When the operation mode of the electronic device 200 is the communication mode, the CPU 205 controls the regulator 208 to supply the power discharged from the battery 210 to the communication unit 212, the recording unit 215, and the recording medium 215a. In this case, the CPU 205 controls the regulator 208 in such a way as to prevent the power discharged from the battery 210 from being supplied to the imaging unit 213.

In this case, the process of flowchart proceeds from step S619 to step S620.

In step S620, the CPU 205 controls the electronic device 200 to continuously perform the predetermined process that is started in step S604.

If it is determined that the operation power W is less than the received power (No in step S618), the CPU 205 controls the electronic device 200 to continuously perform the predetermined process that is started in step S604 while the power is received from the power supply apparatus 100. If it is determined that the operation power W is equal to or greater than the received power (Yes in step S618) and the process of step S619 has been completed, the CPU 205 controls the electronic device 200 to continuously perform the predetermined process using the power discharged from the battery 210. In this case, the process of flowchart proceeds from step S620 to step S611. If the predetermined process is not performed in step S604, then in step S620, the CPU 205 performs a predetermined process according to the operation mode of the electronic device 200.

In step S621, similar to step S508, the CPU 105 determines whether the time measured by the timer 211 has reached the second time. If the CPU 205 determines that the time measured by the timer 211 has not yet reached the second time (No in step S621), the process of flowchart proceeds from step S621 to step S623. If the CPU 205 determines that the time measured by the timer 211 has reached the second time (Yes in step S621), the CPU 205 causes the timer 211 to stop measuring the time and deletes the time measured by the timer 211 from the RAM 207. In this case (Yes in step S621), the process of flowchart proceeds from step S621 to step S622.

In step S622, similar to step S614, the CPU 205 stops the discharging of the battery 210. In this case, the process of flowchart proceeds from step S622 to step S603.

In step S623, the CPU 205 performs a command reception process. The command reception process to be performed in step S623 is similar to the process illustrated in FIG. 4. When the command reception process has been completed, the processing of flowchart returns from step S623 to step S624.

In step S624, similar to step S603, the CPU 205 determines whether the remaining capacity of the battery 210 is equal to or greater than the predetermined value E2. If the CPU 205 determines that the remaining capacity of the battery 210 is equal to or greater than the predetermined value E2 (Yes in step S624), the process of flowchart returns from step S624 to step S608. If the CPU 205 determines that the remaining capacity of the battery 210 is less than the predetermined value E2 (No in step S624), the process of flowchart proceeds from step S624 to step S625.

In step S625, similar to step S609, the CPU 205 controls the electronic device 200 to stop the predetermined process that is started in step S604. When the predetermined process stop operation has been completed, the process of flowchart proceeds from step S625 to step S626.

In step S626, similar to step S614, the CPU 205 stops the discharging of the battery 210. In this case, the process of flowchart returns from step S626 to step S611. If the CPU 205 does not discharge the battery 210, the CPU 205 can skip the process of step S626 and perform the process of step S611.

If it is detected that the battery 210 is in a fully-charged state while the second charging process illustrated in FIG. 6 is performed, the CPU 205 can control the charging control unit 209 to stop the charging of the battery 210.

(Third Charging Process)

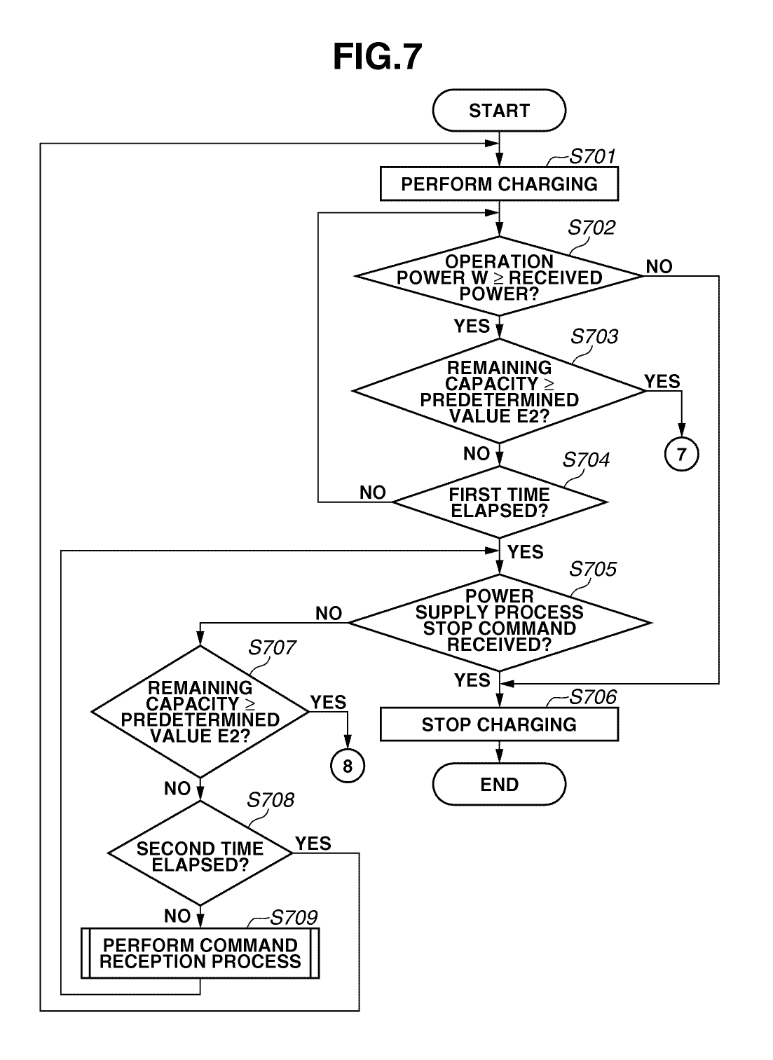

The third charging process to be performed by the electronic device 200 in step S615 of the second charging process illustrated in FIG. 6 is described below with reference to a flowchart of FIG. 7. The third charging process is an example process that can be performed by the electronic device 200 to charge the battery 210, when the operation mode of the electronic device 200 is any one of the second charging mode, the shooting mode, the reproduction mode, and the communication mode, in a state where the predetermined process according to the operation mode of the electronic device 200 is not performed.

When the third charging process illustrated in FIG. 7 is performed, the power received from the power supply apparatus 100 can be supplied to the regulator 208, the CPU 205, the ROM 206, the RAM 207, and the timer 211. Further, in this case, the power received from the power supply apparatus 100 can be supplied to the modulation and demodulation circuit 204, the matching circuit 202, the rectifying and smoothing circuit 203, the operation unit 216, and the current and voltage detection unit 214.

To realize the third charging process illustrated in FIG. 7, the CPU 205 executes a computer program loaded from the ROM 206. The third charging process illustrated in FIG. 7 includes process contents that are similar to those of the first charging process illustrated in FIG. 5 or the second charging process illustrated in FIG. 6, although their descriptions are not repeated.

In step S701, similar to step S605, the CPU 205 controls the charging control unit 209 to supply the power received from the power supply apparatus 100 to the charging control unit 209 and the battery 210 and charge the battery 210. Further, the CPU 105 controls the timer 211 to measure the time elapsed since the charging control unit 209 started the charging of the battery 210. In this case, the process of flowchart proceeds from step S701 to step S702.

In step S702, similar to step S606, the CPU 205 determines whether the operation power W of the electronic device 200 is equal to or greater than the received power. If the CPU 205 determines that the operation power W is equal to or greater than the received power (Yes in step S702), the process of flowchart proceeds from step S702 to step S703. If the CPU 205 determines that the operation power W is less than the received power (No in step S702), the process of flowchart proceeds from step S702 to step S706.

In step S703, similar to step S603, the CPU 205 determines whether the remaining capacity of the battery 210 is equal to or greater than the predetermined value E2. If the CPU 205 determines that the remaining capacity of the battery 210 is equal to or greater than the predetermined value E2 (Yes in step S703), the process of flowchart proceeds from step S703 to step S603. If the CPU 205 determines that the remaining capacity of the battery 210 is less than the predetermined value E2 (No in step S703), the process of flowchart proceeds from step S703 to step S704.

In step S704, similar to step S505, the CPU 105 determines whether the time measured by the timer 211 has reached the first time. If the CPU 205 determines that the time measured by the timer 211 has reached the first time (Yes in step S704), the CPU 205 causes the timer 211 to stop measuring the time and deletes the time measured by the timer 211 from the RAM 207. Further, the CPU 205 controls the timer 211 to measure the time elapsed since the elapse of the first time. In this case (Yes in step S704), the process of flowchart proceeds from step S704 to step S705. If the CPU 205 determines that the time measured by the timer 211 has not yet reached the first time (No in step S704), the process of flowchart returns from step S704 to step S702.

In step S705, similar to step S611, the CPU 205 determines whether the modulation and demodulation circuit 204 has received the fifth command from the power supply apparatus 100. If the CPU 205 determines that the modulation and demodulation circuit 204 has not yet received the fifth command from the power supply apparatus 100 (No in step S705), the process of flowchart proceeds from step S705 to step S707. If the CPU 205 determines that the modulation and demodulation circuit 204 has received the fifth command from the power supply apparatus 100 (Yes in step S705), the process of flowchart proceeds from step S705 to step S706. In this case (Yes in step S705), the CPU 205 controls the modulation and demodulation circuit 204 to perform load modulation to transmit a response signal that corresponds to the fifth command to the power supply apparatus 100.

In step S706, the CPU 205 controls the charging control unit 209 to stop the charging of the battery 210. In this case, the CPU 205 terminates the process of the flowchart illustrated in FIG. 7.

In step S707, similar to step S603, the CPU 205 determines whether the remaining capacity of the battery 210 is equal to or greater than the predetermined value E2. If the CPU 205 determines that the remaining capacity of the battery 210 is equal to or greater than the predetermined value E2 (Yes in step S707), the process of flowchart proceeds from step S707 to step S608. If the CPU 205 determines that the remaining capacity of the battery 210 is less than the predetermined value E2 (No in step S707), the process of flowchart proceeds from step S707 to step S708.

In step S708, similar to step S621, the CPU 105 determines whether the time measured by the timer 211 has reached the second time. If the CPU 205 determines that the time measured by the timer 211 has not yet reached the second time (No in step S708), the process of flowchart proceeds from step S708 to step S709. If the CPU 205 determines that the time measured by the timer 211 has reached the second time (Yes in step S708), the CPU 205 causes the timer 211 to stop measuring the time and deletes the time measured by the timer 211 from the RAM 207. In this case (Yes in step S708), the process of flowchart returns from step S708 to step S701.

In step S709, the CPU 205 performs a command reception process. The command reception process to be performed in step S709 is similar to the process illustrated in FIG. 4. If the command reception process has been completed, the process of flowchart returns from step S709 to step S705.

In step S603 of the second charging process illustrated in FIG. 6, the CPU 205 determines whether the remaining capacity of the battery 210 is equal to or greater than the predetermined value E2.

If it is determined that the remaining capacity of the battery 210 is equal to or greater than the predetermined value E2 (Yes in step S603), the electronic device performs a predetermined process that corresponds to the operation mode of the electronic device 200 according to the power received from the power supply apparatus 100. In this case, the remaining capacity of the battery 210 is equal to or greater than the predetermined value E2. Therefore, even when the power output from the power supply apparatus 100 is changed from the second power to the first power, the electronic device 200 can use the power discharged from the battery 210. Therefore, using the power discharged from the battery 210, the electronic device 200 can continuously perform the predetermined process according to the operation mode of the electronic device 200 without any interruption.

If the remaining capacity of the battery 210 is less than the predetermined value E2 (No in step S603), the CPU 205 performs the third charging process without performing the predetermined process according to the operation mode of the electronic device 200. In this case, in the third charging process, the electronic device 200 performs only the charging of the battery 210. Further, in the third charging process, after the remaining capacity of the battery 210 becomes equal to or greater than the predetermined value E2, the CPU 205 performs the predetermined process according to the operation mode of the electronic device 200.

In this case, the remaining capacity of the battery 210 is equal to or greater than the predetermined value E2. Therefore, even when the power output from the power supply apparatus 100 is changed from the second power to the first power, the electronic device 200 can use the power discharged from the battery 210. Therefore, using the power discharged from the battery 210, the electronic device 200 can continuously perform the predetermined process according to the operation mode of the electronic device 200 without any interruption.

In step S618 of the second charging process illustrated in FIG. 6, the CPU 205 determines whether the operation power W of the electronic device 200 is equal to or greater than the received power.

When the operation power W of the electronic device 200 is equal to or greater than the received power (Yes in step S618), the CPU 205 performs the predetermined process according to the operation mode of the electronic device 200 using the power discharged from the battery 210. In this case, even when the power output from the power supply apparatus 100 is changed from the second power to the first power, the CPU 205 can continuously perform the predetermined process using the power discharged from the battery 210, according to the operation mode of the electronic device 200 without any interruption.

When the operation power W of the electronic device 200 is less than the received power (No in step S618), the CPU 205 performs the predetermined process according to the operation mode of the electronic device 200 using the power received from the power supply apparatus 100. In this case, even when the power output from the power supply apparatus 100 is changed from the second power to the first power, the CPU 205 can continuously perform the predetermined process using the power received from the power supply apparatus 100, according to the operation mode of the electronic device 200 without any interruption.

As described above, the power supply apparatus 100 according to the first exemplary embodiment sets the communication time during which the power supply apparatus 100 communicates with the electronic device 200 using a command while outputting the first power and sets the power supply time during which the power supply apparatus 100 outputs the second power, with reference to the operational state of the electronic device 200.

To set the communication time according to the type of the electronic device 200, the power supply apparatus 100 can appropriately set the time during which the power supply apparatus 100 acquires information required to control the power supply to the electronic device 200 from the electronic device 200. Thus, in a state where the information required to control the power supply to the electronic device 200 is not yet acquired from the electronic device 200, it is feasible to prevent the power supply apparatus 100 from outputting the second power to the electronic device 200. Thus, the power supply apparatus 100 can appropriately set the second power supplied to the electronic device 200 and the power supply time.

Further, the power supply apparatus 100 appropriately sets the power supply time according to the second power, the communication time, and the operation power of the electronic device 200.

Thus, even in a state where the power supply apparatus 100 outputs the first power, the charging of the battery 210 is controlled to enable the electronic device 200 to perform the predetermined operation using the power supplied from the battery 210.

Therefore, even when the power supply apparatus 100 cannot supply sufficient power to the electronic device 200 until the communication time elapses after the first power output timing, the electronic device 200 can receive sufficient power from the battery 210 that is charged during the power supply time.

In this case, the electronic device 200 can perform the predetermined operation using the power supplied from the power supply apparatus 100 until the power supply time elapses after the second power output timing. Further, the electronic device 200 can perform the predetermined operation using the power supplied from the battery 210 until the communication time elapses after the first power output timing. Even when the communication time has not yet elapsed after the first power output timing, the power required for the predetermined operation to be performed by the electronic device 200 can be supplied from the battery 210. Therefore, the electronic device 200 does not interrupt the predetermined operation.

Therefore, the power supply apparatus 100 can perform communications to acquire the information required to control the power supply to the electronic device 200 without interrupting the predetermined operation performed by the electronic device 200.

Further, if the operation mode of the electronic device 200 is changed, the power supply apparatus 100 resets the second power and the power supply time. Thus, the power supply apparatus 100 can supply appropriate power to the electronic device 200 according to the operational state of the electronic device 200.

Further, if the state of the battery 210 connected to the electronic device 200 is changed, the power supply apparatus 100 resets the second power and the power supply time. Thus, the power supply apparatus 100 can supply appropriate power to the electronic device 200 according to the state of the battery 210 of the electronic device 200.

In the first exemplary embodiment, before the communication time elapses after the power supply apparatus 100 outputs the first power, the power supply apparatus 100 acquires the operation information of the electronic device 200 and the charging information of the electronic device 200 from the electronic device 200. However, the operation of the power supply apparatus 100 is not limited to the above-described example.

For example, when the device information of the electronic device 200 indicates that the electronic device 200 is an imaging apparatus, the power supply apparatus 100 can acquire the operation information of the electronic device 200 and shooting information of the electronic device 200 from the electronic device 200 before the communication time elapses after the first power output timing. In this case, in step S209, the CPU 105 sets the communication time A to be sufficient to acquire the operation information of the electronic device 200 and the shooting information of the electronic device 200 from the electronic device 200. The shooting information of the electronic device 200 includes information indicating shooting settings of the electronic device 200, information indicating the number of capturable still images, and information indicating moving image recordable time.

Further, for example, when the device information of the electronic device 200 indicates that the electronic device 200 is a reproduction apparatus, the power supply apparatus 100 can acquire the operation information of the electronic device 200 and reproduction information of the electronic device 200 from the electronic device 200. In this case, in step S209, the CPU 105 sets the communication time A to be sufficient to acquire the operation information of the electronic device 200 and reproduction information of the electronic device 200 from the electronic device 200. The reproduction information of the electronic device 200 includes information indicating whether the electronic device 200 performs slide show reproduction and information indicating data recorded in a recording medium connected to the electronic device 200.

Further, for example, when the device information of the electronic device 200 indicates that the electronic device 200 is a communication apparatus that can perform communications via the communication unit 212, the power supply apparatus 100 can acquire the operation information of the electronic device 200 and communication information of the electronic device 200. In this case, in step S209, the CPU 105 sets the communication time A to be sufficient to acquire the operation information of the electronic device 200 and the communication information of the electronic device 200 from the electronic device 200. The communication information of the electronic device 200 includes information indicating a communication method applicable to the electronic device 200, information indicating a data transmission state of the electronic device 200, and information indicating a communication connection state of the electronic device 200.

### Other Exemplary Embodiment

The power supply apparatus according to the present invention is not limited to the power supply apparatus 100 described in the first exemplary embodiment. Further, the electronic device according to the present invention is not limited to the electronic device 200 described in the first exemplary embodiment. For example, the power supply apparatus and the electronic device according to the present invention can be realized as a system including a plurality of apparatuses.

Further, a computer program is usable to realize the processes and the functions of the power supply apparatus 100 described in the first exemplary embodiment. Further, a computer program is usable to realize the processes and the functions of the electronic device 200 described in the first exemplary embodiment. In this case, a computer (including a CPU) executes the computer program according to the present invention to realize various functions described in the first exemplary embodiment.

An operating system (OS) running on a computer is usable to execute the computer program according to the present invention to realize various processes and functions described in the first exemplary embodiment.

The computer program according to the present invention can be read from a computer-readable recording medium and can be executed by a computer. The computer-readable recording medium can be any one of a hard disk device, an optical disk, a compact disc read-only memory (CD-ROM), a compact disc-recordable (CD-R), a memory card, and a ROM. Further, an external apparatus can provide the computer program according to the present invention to a computer that executes the program, via a communication interface.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-171133 filed Aug. 4, 2011, which is hereby incorporated by reference herein in its entirety.

What is claimed is:

1. A power supply apparatus comprising:
a power supply unit that supplies power wirelessly to an electronic device; and
a setting unit that sets a first time and a second time,
wherein the first time includes a period of time that the power supply unit outputs a first power, the first power is used for communicating with the electronic device,
the second time includes a period of time that the power supply unit outputs a second power, and the second power is greater than the first power.

2. The power supply apparatus according to claim 1, wherein the second time is longer than the first time.

3. The power supply apparatus according to claim 1, wherein the first time is set based on a type of the electronic device.

4. The power supply apparatus according to claim 1, wherein the second time is set based on an operational state of the electronic device.

5. The power supply apparatus according to claim 1, wherein the second power is set based on an operational state of the electronic device and a remaining capacity of a battery charged by the electronic device.

6. The power supply apparatus according to claim 1, wherein predetermined data is transmitted to the electronic device if the first power is outputted, wherein the predetermined data is not transmitted to the electronic device if the second power is outputted, and wherein the predetermined data is used to control the electronic device.

7. The power supply apparatus according to claim 6, wherein the predetermined data includes data relating to a type of the electronic device.

8. The power supply apparatus according to claim 6, wherein the predetermined data includes at least one of first data and second data, wherein the first data is used for requesting information indicating a remaining capacity of a battery charged by the electronic device, and wherein the second data is used for requesting information indicating an operational state of the electronic device.

9. The power supply apparatus according to claim 1, wherein the power supply unit outputs the second power until the second time elapses, and wherein the power supply unit outputs the first power until the first time elapses after the second time elapses.

10. The power supply apparatus according to claim 1, wherein the setting unit sets the second time again if an operational state of the electronic device is changed.

11. The power supply apparatus according to claim 1, wherein a value of the second power is changed if an operational state of the electronic device is changed.

12. The power supply apparatus according to claim 1, wherein the setting unit sets the second time again if a battery is fully charged by the electronic device.

13. The power supply apparatus according to claim 1, wherein a value of the second power is changed if a battery is fully charged by the electronic device.

14. An electronic device comprising:
a power receiving unit that receives power;
an operation unit that performs a predetermined operation; and
a control unit that performs a process for supplying received power to the operation unit if the received power is greater than or equal to a predetermined value, wherein the control unit supplies power received from a battery to the operation unit if the received power is less than the predetermined value.

15. The electronic device according to claim 14, wherein the control unit charges the battery using the received power if the received power is greater than or equal to the predetermined value.

16. The electronic device according to claim 14, wherein the control unit performs at least one of a first process and a second process, wherein the first process includes process for transmitting information relating to the predetermined operation to a power supply apparatus, and wherein the second process includes process for transmitting information relating to the battery to the power supply apparatus.

17. A control method comprising:
supplying power wirelessly to an electronic device; and
setting a first time and a second time,
wherein the first time includes a period of time that the first power is outputted, wherein the first power is used for communicating with the electronic device, and
wherein the second time includes a period of time that the second power is outputted, and wherein the second power is greater than the first power.

18. A non-transitory computer readable recording medium storing a program executable by a computer to perform a control method, the control method comprising:
supplying power wirelessly to an electronic device; and
setting a first time and a second time,
wherein the first time includes a period of time that the first power is outputted, wherein the first power is used for communicating with the electronic device, and
wherein the second time includes a period of time that the second power is outputted, wherein the second power is greater than the first power.

19. A control method comprising:
receiving power;
performing a predetermined operation by using the received power if the received power is greater than or equal to a predetermined value;
and
performing the predetermined operation by using a battery if the received power is less than the predetermined value.

20. A non-transitory computer readable recording medium storing a program executable by a computer to perform a control method, the control method comprising:
performing a predetermined operation by using the received power if the received power is greater than or equal to a predetermined value; and
performing the predetermined operation by using a battery if the received power is less than the predetermined value.
